(19) United States
(12) Patent Application Publication
(10) Pub. No.: US 2025/0382110 A1
(43) Pub. Date: Dec. 18, 2025

(54) FOOD PREPARATION VESSEL FOR A KITCHEN APPLIANCE AND KITCHEN APPLIANCE

(71) Applicant: Vorwerk &Co. Interholding GmbH, Wuppertal (DE)

(72) Inventors: Christian Bayard, Witten (DE); Sebastian Jansen, Bochum (DE); Felix Thies, Burgdorf (DE)

(21) Appl. No.: 19/190,927

(22) Filed: Apr. 28, 2025

(30) Foreign Application Priority Data
May 2, 2024 (EP) 24173953.1

(51) Int. Cl. B65D 45/00

(52) U.S. Cl. CPC B65D 45/00

(57) ABSTRACT

A preparation module arrangeable in a receiving area of a kitchen appliance base, the preparation module having at least one preparation vessel and lid, the preparation vessel having at least one preparation chamber and at least one locking unit, the lid being removable in at least one release position of the locking unit and is locked with the preparation vessel in at least one locking position of the locking unit, wherein the locking unit has at least one blocking means, which in a blocking position prevents movement of the locking unit at least into the release position, at least when a force from the preparation chamber acts on the lid. The locking unit is at least partially moved toward the release position when the blocking means is in the blocking position, and that the blocking means reaches the blocking position at least through a translational movement of the lid.

### CROSS REFERENCE TO RELATED APPLICATIONS

This application claims the benefit of priority under 35 U.S.C. § 119 to European Patent Application No.: 24173953.1, filed May 2, 2024, the contents of which is incorporated herein by reference in its entirety.

### FIELD

The invention relates to a preparation module for arrangement in a receiving area of a kitchen appliance base, in particular of a kitchen appliance. The preparation module has at least one preparation vessel and at least one lid.

### BACKGROUND

The statements in this section merely provide background information related to the present disclosure and several definitions for terms used in the present disclosure and may not constitute prior art.

Kitchen appliances with kitchen appliance base and preparation module, for example comprising a preparation vessel and at least one lid, are known to exist in a variety of configurations. Such kitchen appliances serve for automatic, semi-automatic or manual preparation, e.g., chopping, grinding, pressing, stirring, cooking, steaming and/or keeping warm, in particular of food. The kitchen appliance usually has a kitchen appliance base that provides at least one receiving area for at least one preparation module, e.g., with a preparation vessel. The receiving area often has at least one electrical interface to supply a preparation module arranged in the receiving area with at least one working voltage, for example for a heating device of the preparation module, or to contact sensors, for example.

Alternatively or additionally, at least one mechanical interface, e.g., a tool interface, is provided in the receiving area, which serves, for example, for transmitting torque from a working unit, e.g., a motor, of the kitchen appliance base to a tool arranged on the preparation module, for example.

In order to lock the lid with the preparation vessel during the preparation of food in the preparation vessel, for example, the preparation vessel has at least one lid locking unit with which the lid can be fixed and released. The blocking means cooperates with the lid locking unit and prevents movement of the lid locking unit into the release position, at least when a force from the preparation chamber acts on the lid.

However, the blocking means known from the prior art have the disadvantage that to prevent the escape of rotating liquid vortices, a dwell time occurs before unlocking the lid so that a liquid vortex can settle. However, this also occurs when no vortex has actually formed. This creates waiting times for the user that reduce user comfort.

### SUMMARY

The present disclosure is therefore based on the objective of providing a preparation module with a preparation vessel and a kitchen appliance in which advantageous locking and unlocking of the lid is enabled, but at the same time high user comfort is ensured by reducing waiting times during lid unlocking.

The aforementioned objective is solved in a preparation module for arrangement in a receiving area of a kitchen appliance base, wherein the preparation module has at least one preparation vessel and at least one lid, wherein the preparation vessel has at least one preparation chamber for receiving food and at least one lid locking unit, wherein the lid is removable in at least one lid release position of the lid locking unit and is locked with the preparation vessel in at least one lid locking position of the lid locking unit, wherein the lid locking unit has at least one blocking means, wherein the blocking means in a blocking position prevents movement of the lid locking unit at least into the lid release position, at least when a force from the preparation chamber acts on the lid. The lid locking unit is at least partially moved in the direction of the release position when the blocking means is in the blocking position, and that the blocking means reaches the blocking position at least through a translational movement of the lid.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows an embodiment of a kitchen appliance with preparation module in perspective view;

FIGS. 2a to 2c shows an embodiment of a lid in different states on a preparation vessel;

FIGS. 3a to 3d shows a schematic representation of the function of a blocking means;

FIG. 4 shows a preparation vessel according to FIG. 1 in perspective view;

FIG. 5 shows the preparation vessel according to FIG. 4 in partial exploded view;

FIG. 6 shows a part of a preparation vessel according to FIG. 4 in perspective view;

FIG. 7 shows an embodiment of a housing for a preparation vessel;

FIG. 7a shows a detail view of the housing according to FIG. 7;

FIG. 8 shows an embodiment of a locking unit in perspective view;

FIG. 9 shows the embodiment of a preparation module according to FIG. 1 without housing;

FIGS. 10a and 10b show an embodiment of a counter-element with transmission element and lid locking element;

FIG. 11 shows an embodiment of a preparation module in perspective view from below;

FIGS. 12a to 12c show an exemplary sequence of locking a tool holder in a preparation vessel;

FIG. 13 shows an embodiment of a lid from the lid underside;

FIG. 14 shows an embodiment of a support unit on a preparation module;

FIG. 15 shows a sectional view in the area of the lid of a preparation module;

FIG. 16 shows a receiving area of a kitchen appliance base in perspective view in a first state;

FIG. 17 shows the receiving area according to FIG. 16 in a second state;

FIG. 18 shows a section through the receiving area with attached preparation vessel;

FIG. 19 shows a detail view of an embodiment of a housing from the underside;

FIG. 20 shows an embodiment of a housing in perspective view;

FIG. 21 shows an embodiment of a kitchen appliance base in partial section; and

FIG. 22 shows an embodiment of a functional module in sectional view.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the present disclosure provides a preparation module for arrangement in a receiving area of a kitchen appliance base, in particular of a kitchen appliance. The preparation module has at least one preparation vessel and at least one lid. The preparation vessel has at least one preparation chamber for receiving food and at least one lid locking unit. The lid locking unit has at least one blocking means. The lid is removable from the preparation vessel in at least one lid release position of the lid locking unit and closes the preparation chamber in at least one lid locking position of the lid locking unit. In the lid locking position, the lid is locked with the preparation vessel. The blocking means is provided to prevent, in a blocking position, movement of the lid locking unit into the release position, at least when a force from the preparation chamber acts on the lid or, for example, a user pulls on the lid, in particular in a direction parallel to a longitudinal axis L of the preparation vessel.

According to one aspect of the present disclosure, the preparation vessel of the preparation module is designed and configured for arrangement in a receiving area of a kitchen appliance base of a kitchen appliance. The preparation module serves—when used with a kitchen appliance base—for automatic, semi-automatic or manual preparation, e.g., chopping, grinding, pressing, stirring, cooking, steaming and/or keeping warm, in particular of food. The preparation vessel has in particular at least one electrical heating means for heating the preparation chamber. Furthermore, the preparation vessel has at least one electrical interface, for example for contacting the heating means and/or for contacting sensors. The electrical interface is designed in particular for cooperation with an electrical counter-interface of the kitchen appliance base.

Furthermore, the preparation vessel preferably has at least one mechanical interface, for example for transmitting torque, for a tool, which is designed for cooperation with a mechanical counter-interface of the kitchen appliance base, in particular a tool interface. The preparation vessel preferably has at least one rotatable tool that is firmly connected to the preparation vessel or is detachably held in the preparation vessel, in particular on a tool holder. In particular, the tool is coupled to the mechanical interface.

The preparation chamber of the preparation vessel can be closed with the lid, wherein the lid can be locked using the lid locking unit. Advantageously, at least one seal is arranged between the lid and the preparation vessel. Preferably, the seal is designed for centering the lid when placing it on. For example, the seal is held on the lid by a welded retaining ring. The lid locking unit is advantageously movable, in particular rotatable, between a lid release position in which the lid is removable and a lid locking position in which the lid closes the preparation chamber and is locked with the preparation vessel.

According to one embodiment, the preparation module has at least one preparation vessel and at least one lid. It is preferably provided that the preparation module has at least one lid, in particular for at least partially or completely closing the preparation chamber. However, it is also provided that the lid locking element can be used for locking special lids that do not serve or do not only serve to close the preparation vessel. The preparation module preferably has at least one functional module. The functional module can be placed on a lid and/or the preparation vessel, for example, and/or can be partially or completely introduced into the preparation vessel, in particular into a preparation chamber. The functional module is designed, for example, as attachment accessories or as insert accessories. It is preferably provided that the lid is designed as a functional module. This is equivalent to the functional module having a lid interface.

Furthermore, it is advantageously provided that the functional module has at least one connection interface for cooperation with a tool and/or a tool holder of the preparation vessel in order to use, for example, a rotation of the tool. This is particularly useful for a functional module that has a tool function—an accessory tool—e.g., a juicing module, a cutting module or a peeling module.

Preferably, the functional module has at least one lid interface to cooperate with a lid locking unit of the preparation vessel, in particular a lid locking element, and to lock and unlock the functional module—like a lid—with the accessory vessel. The functional module is reliably held on the preparation vessel or in the preparation vessel during use through the cooperation. In this sense, the functional module represents in particular a special lid. The lid interface preferably has some or all features of the described features of a lid that it needs for cooperation with the lid locking unit, in particular the lid locking element. In particular, for example, at least one or a plurality of cams and/or centering elements and/or a support unit.

The functional module is, for example, a cleaning module, a stirring module, a juicing module, a steam cooking module, a warming module, a peeling module, a cutting module or a grating module. Each of the aforementioned functional modules is designed, for example, as an insert or as an attachment, e.g., a cleaning insert or a cleaning attachment. Such functional modules that do not have a lid interface and can be completely introduced into the preparation chamber can be used in particular with a normal lid.

The lid or the functional module does not rotate during locking and unlocking in particular. During locking or unlocking, preferably only a translational movement parallel to the rotation axis occurs. Preferably, rotation of the lid or the functional module is prevented by a, in particular form-fitting, cooperation of a support element on the preparation vessel and a support counter-element on the lid.

The preparation vessel preferably has at least one handle for transport and for easier handling. The handle is in particular oriented substantially vertically and is arranged on an outside of the housing of the preparation module.

The blocking means cooperates with the lid locking unit such that further movement of the lid locking unit into the release position is prevented when a force acts on the lid in a direction parallel to a longitudinal axis of the preparation vessel respectively a rotation axis of a tool. The force in this direction is caused, for example, by a rotating liquid vortex or by pressure. Such a force is also caused when a user manually pulls on the lid. In the following, reference is made only to the case of force emanating from the preparation chamber by way of example; however, the explanations should apply equally to a translational movement of the lid caused by a user.

According one aspect of the present disclosure, the cooperation between the blocking means and the lid locking unit only occurs when the lid locking unit has been at least partially moved in the direction of the release position. The blocking position of the blocking means can therefore only be reached when the lid locking unit has already been at least partially moved in the direction of the release position. This has the advantage that a user can recognize that there is no faulty blocking of the lid locking unit, but that the blocking occurs because a force is acting on the lid.

The blocking means is designed such that it prevents further movement of the lid locking unit into the release position when the lid moves translationally with respect to the preparation vessel, i.e., for example, is pushed vertically upward or lifted off. The blocking means in particular prevents liquid or food from unintentionally escaping from the preparation chamber. Due to the force from the preparation chamber or the force of a user, the entire lid advantageously moves slightly, in particular in a direction parallel to a longitudinal axis of the preparation vessel or the rotation axis of a tool, away from the preparation vessel, whereby the blocking means reaches the blocking position. In particular, the lid lifts slightly upward from the preparation vessel without the lid being removed from the preparation vessel. It is in particular provided both that at least one opening to the preparation chamber is formed by the translational movement of the lid through which steam can escape or pressure can be specifically reduced, and that the lid also closes the preparation chamber after the translational movement. It is in particular provided that the lid is not circular but is oval.

It is preferably provided that the lid moves exclusively in the axial direction, in particular parallel to a longitudinal axis of the preparation vessel or a rotation axis of a tool,—translationally—during movement of the lid locking unit between the locking position, the release position and the blocking position. In particular, no rotation of the lid itself occurs during locking and unlocking. Preferably, the lid locking unit is rotatable between a lid locking position and a lid release position.

The present disclosure has the advantage over conventional art that opening of the lid can be effected immediately after preparing food. Only in the case that a force from the preparation chamber actually acts on the lid is this detected based on the translational movement of the lid caused by the force, whereby further release of the lid is blocked. If no force is applied to the lid, opening occurs without interruption, whereby a delay in the opening process only occurs as needed, whereby user comfort is increased by eliminating waiting times and at the same time a high degree of safety is ensured.

According to a first embodiment of the preparation vessel, it is preferably provided that the blocking means has at least one first blocking surface and at least one blocking element, and that the translational movement of the lid is limited by the blocking element resting against the first blocking surface. The blocking means is in particular in the blocking position when the blocking means rests against the first blocking surface. The translational movement of the lid away from the preparation vessel is limited by the blocking element resting against the first blocking surface. The first blocking surface is preferably oriented substantially orthogonally to the direction of movement of the lid. In particular, it is provided that the blocking means has a plurality of first blocking surfaces, preferably at least or exactly three or at least or exactly four first blocking surfaces. For example, the blocking element is arranged on the lid and the blocking surface is arranged on the preparation vessel.

For example, it is provided that the first blocking surface is a surface in a recess. In particular, the lid locking unit has at least one recess and the first blocking surface is part of the recess. Preferably, the lid performs a slight movement away from the preparation vessel to let the blocking element rest against the first blocking surface. For example, it is provided that this movement of the lid is detected by a sensor, for example a position sensor, which then immediately stops further movement of the lid locking unit, for example by stopping a motor of a drive unit.

In particular to enable mechanical blocking of the blocking means, according to a further embodiment of the preparation module it is provided that the blocking means has at least one second blocking surface, and that the blocking element in the blocking position is mechanically prevented from further movement in at least one direction, in particular in the direction of the release position, by at least partially resting against the second blocking surface. The second blocking surface is, for example, a surface of a recess. Preferably, the second blocking surface is oriented substantially parallel or inclined to a direction of movement of the blocking element during movement of the lid or parallel or inclined to a longitudinal axis of the preparation vessel. If, for example, the lid locking unit is rotated in the direction of the lid release position, further rotation of the lid locking unit is mechanically prevented by the blocking element resting against the second blocking surface. In particular, it is provided that the blocking means has a plurality of second blocking surfaces, preferably at least or exactly three or at least or exactly four second blocking surfaces.

It is preferably provided that the mechanical blocking of the blocking element by the second blocking surface is detected, for example via the detection of a current strength at a motor of the drive unit, so that a drive of the lid locking unit can be switched off, in particular by a control unit of the kitchen appliance base. For example, the first blocking surface and the second blocking surface are oriented at an angle between 80° and 155°, preferably between 120° and 140°, in particular of 90° or 135°, to each other. For example, the second blocking surface is a side surface of a recess. Preferably, the blocking element in the blocking position rests at least partially against both the first blocking surface and the second blocking surface.

The present disclosure can be realized in a simple manner in that according to one embodiment it is provided that the lid locking unit has at least one lid locking element rotatably mounted about a rotation axis, and that at least the first blocking surface is formed on the lid locking element. The lid locking element is preferably ring-like. For example, the lid locking element is held rotatably on the preparation vessel relative to the lid and relative to the preparation chamber. A rotation of the lid locking element in a first direction of rotation causes, for example, locking of the lid with the preparation vessel. A rotation of the lid locking element in a second direction of rotation opposite to the first direction of rotation causes, for example, a release of the lid, provided that movement in the second direction of rotation is not blocked by the blocking means, in particular the blocking element cooperating with the first blocking surface. It is preferably provided that the blocking element is arranged on an inner surface of the lid and the blocking surface is arranged on a radially outward-facing surface of the lid locking unit respectively the lid locking element.

Preferably, the lid locking element is arranged such that it is almost completely covered by the lid. Preferably, the size of the visible part of the lid locking element is increased when the blocking means is in the blocking position, i.e., the lid has at least partially lifted off from the preparation chamber.

According to a further embodiment of the preparation module, it is provided that the lid locking unit has at least one locking cam track and at least one cam for locking the lid. The locking cam track represents a contour in which the cam is guided during movement of the lid locking unit to lock or unlock the lid when it is moved, in particular rotated, relative to the cam. For example, the locking cam track has at least one run-up slope that, in cooperation with the cam, causes the lid to be drawn toward the preparation vessel by the cam sliding on the run-up slope. It is preferably provided that at least the first blocking surface and/or the second blocking surface of the blocking means is formed on the locking cam track respectively in the course of the locking cam track. Preferably, the first blocking surface is formed immediately adjacent to the run-up slope.

The run-up slope is preferably designed such that during movement of the lid locking unit, in particular during rotation of the lid locking element, it causes at least an axial displacement of the cam in a direction parallel to a longitudinal axis of the preparation vessel. Thereby, the lid is brought closer to the preparation vessel by the distance along the longitudinal axis by which the cam is also moved by the run-up slope.

It is advantageously provided that the lid locking unit has at least or exactly two, at least or exactly three or at least or exactly four locking cam tracks and at least or exactly two, at least or exactly three or at least or exactly four cams, in particular wherein one cam cooperates with one locking cam track in each case. For example, it is provided that the locking cam track has at least one locking surface. The cam rests against the locking surface in the lid locking position of the lid and is prevented by it from moving in a direction parallel to the longitudinal axis of the preparation vessel, whereby the lid is locked on the preparation vessel.

Alternatively or additionally, it is provided that the first blocking surface is arranged axially offset, in particular along a direction parallel to the longitudinal axis of the preparation vessel, to the locking surface. Between the locking surface and the blocking surface, for example, a step is formed that defines the amount of axial-translational-movement of the lid.

So that the cams can cooperate with the lid locking unit respectively the lid locking element, the inner pot has a number of recesses in an upper edge corresponding to the number of cams. Preferably, at least or exactly four recesses are provided. The recesses are preferably arranged in pairs, wherein an angle of about 60° is formed between the recesses of a pair-starting from the longitudinal axis L. An angle of about 120° is formed between the recesses of the two pairs in each case.

According to a further embodiment of the preparation vessel, it has proven advantageous when it is provided that the cam is also the blocking element of the blocking means, and that the cam is forced into the blocking position, in particular into a recess, during movement in the direction of the lid release position when a force acts on the lid in a direction parallel to a longitudinal axis of the preparation vessel or emanating from the preparation chamber during the movement. The first blocking surface of the blocking means is preferably arranged between the run-up slope and the locking surface of the locking cam track. This ensures that the blocking means is moved past, in particular rotated past, the first and/or second blocking surface during movement of the cam from the lid locking position in the direction of the lid release position and only rests against the first and/or second blocking surface when force acts on the lid or can be moved further in the direction of the lid release position when the lid is force-free.

Preferably, the cam is arranged on the lid and the locking cam track is arranged on a lid locking element rotatable about the rotation axis. The cam is consequently guided by the locking cam track to lock the lid with the preparation vessel, but is also used to block complete unlocking of the lid when a described force acts on the lid. Preferably, the cam rests against the first and second blocking surfaces in a recess in the blocking position. The recess is formed, for example, between the locking surface and the run-up slope on the locking cam track. This recess represents, for example, a setback immediately between the end of the run-up slope and the locking surface.

The cam is only forced into this recess when a force actually acts on the lid in a direction parallel to a longitudinal axis of the preparation vessel. If this force does not act, the cam sweeps over the recess and thus the first and/or second blocking surface and reaches the lid release position without creating a waiting time for the user.

A further embodiment of the preparation module provides for arranging the first blocking surface in the recess. The recess preferably has at least one guide slope that is oriented in the direction of the locking surface of the locking cam track. The guide slope ensures that the cam, after being forced into the recess by the force acting on the lid, can return from the blocking position to the lid locking position during opposite rotation of the lid locking element by the cam sliding along the guide slope. The guide slope is oriented, for example, approximately parallel to the run-up slope, but preferably designed somewhat shorter. The guide slope opens at one end, for example, into the first blocking surface and at a second end into the locking surface of the locking cam track.

According to a further embodiment, the preparation vessel has at least one inner pot and at least one housing. The housing surrounds the inner pot circumferentially, preferably completely circumferentially. The inner pot is removable from the housing and insertable into the housing, preferably detachably lockable with the housing. It is preferably provided that the lid locking element is supported at least in the lid locking position at least partially on an underside of an edge of the inner pot to transmit a force in the axial direction to the housing. The inner pot preferably has an upper edge that extends radially at least partially outward. Preferably, the lid locking element is mounted on the housing of the preparation vessel and is supported at least partially, in particular completely, in the axial and radial directions on the housing.

To advantageously define an end position, for example the lid locking position, according to a further embodiment it is provided that the lid locking unit has at least one stop element. The stop element limits movement of the lid locking unit in the lid locking position. Preferably, the stop element is designed as a projection on the lid locking element, in particular on the locking cam track. When multiple locking cam tracks are present, it is provided both that a stop element is formed on at least or exactly one locking cam track or on at least or exactly two locking cam tracks of the plurality of locking cam tracks, or that a stop element is formed on each locking cam track. The stop element cooperates, for example, with the cam by the cam resting against the stop element in the lid locking position. For example, the stop element protrudes from the locking surface of the locking cam track. Preferably, exactly one cam cooperates with exactly one stop element to define the lid locking position. Preferably, this cam is one of the cams that are arranged on the circumference further away from a support unit than other cams. This position ensures reliable detection of the resting of the one cam against the stop element.

Furthermore, according to a further embodiment, it is in particular provided that the lid locking unit has at least one rotatably mounted lid locking element, and that furthermore at least one counter-element and at least one transmission element are present. The counter-element is advantageously designed for cooperation with a kitchen appliance base, for example in that the counter-element is movable by the kitchen appliance base when the preparation vessel is arranged in the receiving area. The counter-element and the lid locking element are connected to each other via the transmission element such that rotation of the counter-element about a rotation axis, which coincides, for example, with the longitudinal axis of the preparation vessel, causes rotation of the lid locking element. For example, the counter-element, the lid locking element and the transmission element rotate about a common rotation axis.

In particular, it is provided that the transmission element and the counter-element are formed in one piece. The transmission element is then form-fittingly connected to the lid locking element to enable joint rotation. Alternatively, it is provided that the lid locking element, the transmission element and the counter-element are formed in one piece. The lid locking element, the transmission element and the counter-element are formed, for example, from a plastic. The lid locking element, the transmission element and the counter-element are preferably rotatably mounted in the housing of the preparation vessel. For example, the inner pot is removable from the housing, wherein the lid locking element, the transmission element and the counter-element remain in the housing. Preferably, the lid locking element and/or the transmission element and/or the counter-element are designed such that they at least partially surround the inner pot—if it is inserted.

Preferably, according to a further embodiment of the preparation module, it is provided that the inner pot has at least one rib, in particular at a foot area. The rib protrudes, for example, from the foot area in the radial direction. The rib is preferably oriented orthogonally to a rotation axis of a tool for the inner pot or the rib preferably lies in a plane to which the rotation axis is a plane normal. Preferably, the housing, in particular a locking unit in the housing, has at least one counter-rib. The counter-rib is arranged in a locking position of the locking unit such that it collides with the rib on the inner pot when an attempt is made to insert the inner pot into the housing. This prevents the inner pot from being insertable into the housing when the housing is arranged on a kitchen appliance base, in particular, i.e., that the inner pot is subsequently inserted. When the housing—alone—is arranged on the kitchen appliance base, cooperation with the actuating unit prevents unlocking of the locking unit from occurring. In the unlocking position of the locking unit, the inner pot is insertable into the housing.

The present disclosure further relates to a kitchen appliance that has at least one kitchen appliance base and at least one preparation module, with at least one preparation vessel and in particular at least one lid, according to one of the described embodiments. Preferably, the kitchen appliance base is designed and configured such that the preparation module, in particular the preparation vessel, and the kitchen appliance base cooperate at least partially form-fittingly in the receiving area. It is in particular also provided that the preparation module, in particular the preparation vessel, is merely placed in the receiving area.

The receiving area preferably has at least one actuating unit for cooperation with a counter-element of the preparation module, in particular of the preparation vessel. Preferably, movement of the actuating unit can be transmitted to the counter-element so that the counter-element can be moved by the actuating unit. For example, mechanical locking of the preparation module, in particular of the preparation vessel, in the receiving area is possible with the actuating unit and the counter-element.

The actuating unit has at least one drive unit and at least one actuating element rotatably held about a rotation axis as well as at least one stationary holding element. The kitchen appliance base has at least one control unit that is configured and designed to detect whether movement of the counter-element is blocked and to stop movement of the actuating element when blocking is detected.

According to one variant of the present disclosure, blocking exists, for example, when the blocking means is in the blocking position. The control unit is advantageously configured and designed to detect that the blocking means is in the blocking position and to stop movement of the lid locking unit, in particular by stopping the drive unit, when the blocking means is in the blocking position.

It is preferably provided that the control unit is configured and designed to detect the blocking position using at least one current strength of a drive unit, in particular namely by the current strength increasing when the lid locking unit is in the blocking position. Alternatively or additionally, it is provided that the detection occurs using at least one sensor, for example a sensor that detects a position and/or a position change of the lid. If the sensor detects the translational movement of the lid, movement of the actuating unit is stopped, for example by switching off a drive unit. With a sensor, it can be detected, for example, whether a blocking element rests against the first and/or second blocking surface.

For example, the rotatably held actuating element cooperates with the counter-element of the preparation vessel and drives it to lock or unlock the lid with at least the lid locking unit and/or to lock the preparation vessel with the kitchen appliance base and/or to effect a mechanical function on the preparation module. Preferably, a rotation speed of the actuating unit, in particular of the actuating element, of the kitchen appliance base and of the counter-element of the preparation module is the same during rotation.

It is preferably provided that rotation of the counter-element causes locking of the preparation vessel with the kitchen appliance base. The counter-element of the preparation module has in particular at least one active section protruding in the direction of the rotation axis and at least one driver counter-element. The driver counter-element has at least one driver counter-surface for cooperation with a previously described driver element of the kitchen appliance base. The driver counter-surface is arranged offset along a direction parallel to the rotation axis of the counter-element to the active section. In this way, advantageous cooperation of the active section with a holding element of a kitchen appliance base can occur to lock the preparation vessel.

The counter-element has at least one recess into which the driver element can penetrate when introducing the preparation module into the receiving area, in particular along a direction parallel to the rotation axis. By rotating the counter-element, for example, at least one active section is rotated under at least one holding element, whereby the preparation vessel is locked with the kitchen appliance base. The recess is preferably arranged adjacent to the driver counter-element. The number of recesses preferably corresponds to the number of driver elements of the kitchen appliance base. Likewise, the number of active sections corresponds to the number of holding elements of the kitchen appliance base to enable advantageous cooperation of the kitchen appliance base with the preparation module.

The kitchen appliance base advantageously has a weighing function so that food arranged in or on a preparation module can be weighed. It is in particular provided that weighing sensors are arranged on the feet of the kitchen appliance base and/or that weighing sensors are arranged in the receiving area.

According to one embodiment of the kitchen appliance, it is provided that the control unit is configured and designed to cause the drive unit to transfer the lid locking unit to the release position when the control unit detects that the blocking means is no longer in the blocking position, in particular completely outside the blocking position. Alternatively or additionally, it is provided that the control unit is configured and designed to cause the drive unit to transfer the lid locking unit to the release position when a predetermined waiting time has elapsed after the control unit has detected that the blocking means is in the blocking position. During the waiting time, for example, rotating liquid vortices can settle so that no force acts on the lid from the preparation chamber and the lid can be opened.

A further embodiment of the kitchen appliance provides that the control unit is configured and designed to cause the drive unit, after detecting that the blocking means is in the blocking position, to transfer the lid locking unit back to the locking position and, in particular after a predetermined waiting time, to move the lid locking unit again in the direction of the release position. When the lid locking unit is blocked by the blocking means in the blocking position when transferring to the lid release position, the blocking element, for example the cam, is preferably moved back to the blocking position, i.e., to the starting position-here the lid locking position. After a waiting time during which, for example, the force from the preparation chamber can be reduced, another opening attempt is started by moving the lid locking unit in the direction of the release position. In particular, the lid locking element is rotated in the direction of the release position.

The control unit is preferably configured and designed to repeat the previously described processes individually or in combination until the lid locking unit is transferred to the release position without the blocking means reaching the blocking position.

The present disclosure further relates to a method for operating a preparation module with a preparation vessel and a lid or a functional module, in particular a preparation module with at least some of the features of a described embodiment. The method has at least the following method steps:
Rotating a lid locking unit on the preparation vessel about a rotation axis at least between a lid release position and a lid locking position to lock and unlock the lid. Preferably, the rotation of the lid locking unit is effected by means of an actuating unit of a kitchen appliance base.
Moving a blocking means to a blocking position when at least one force from the preparation chamber acts on the lid during rotation of the lid locking unit in the direction of the lid release position, wherein moving the blocking means to the blocking position comprises a translational movement of the lid relative to the preparation vessel, in particular in a direction parallel to the rotation axis. The moving is effected by the force acting on the lid, which can alternatively also be applied, for example, by a user when the user pulls on the lid during unlocking.

Further embodiments of the functional and structural features of the method result from the description of the embodiments of the preparation vessel, the kitchen appliance base or the kitchen appliance and their function.

In addition, the present disclosure relates to a use of a preparation module according to one of the described embodiments on a kitchen appliance base, in particular on a kitchen appliance base respectively a kitchen appliance according to one of the described embodiments.

Further advantageous embodiments of the present disclosure result from the following figure description. In the various figures of the drawing, identical parts are always provided with the same reference numerals.

For the following description, it is claimed that the present disclosure is not limited to the embodiments and thereby not limited to all or several features of described feature combinations, rather each individual partial feature of the/each embodiment is also significant for the subject matter of the present disclosure detached from all other partial features described in connection therewith, and also in combination with any features of another embodiment.

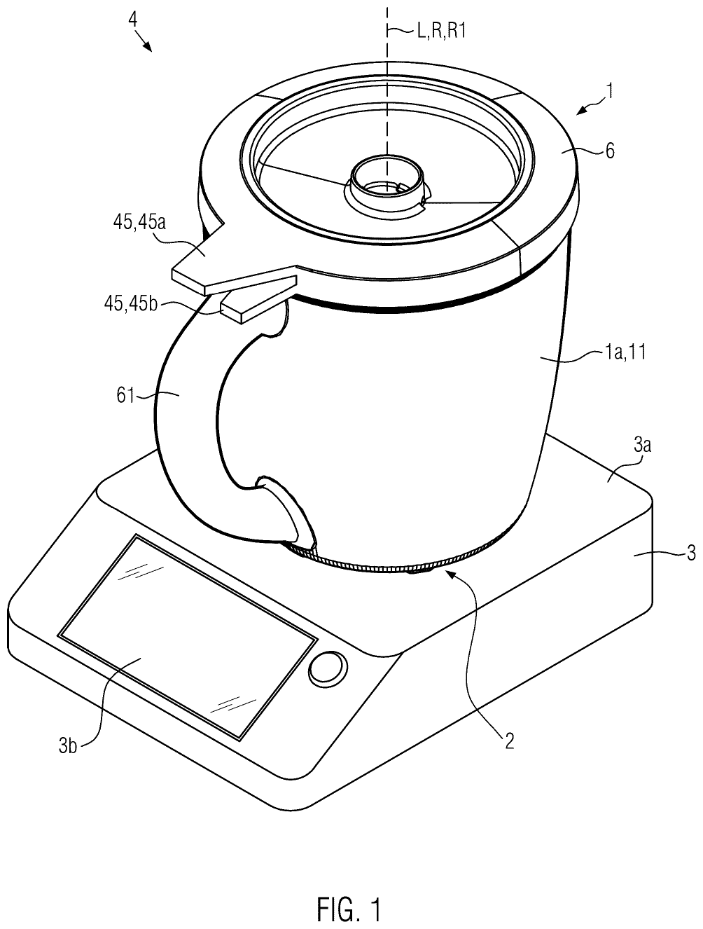

FIG. 1 shows an embodiment of a preparation module 1 that is intended for arrangement in a receiving area 2 of a kitchen appliance base 3 of a kitchen appliance 4. The preparation module 1 here comprises a preparation vessel 1a and a lid 6. The preparation vessel 1 can be placed on a flat top surface 3a of the kitchen appliance base 3 to cooperate with the kitchen appliance base 3. The kitchen appliance base 3 has at least one combined display and input device 3b in the form of a touchscreen to control functions of the kitchen appliance 4. Additionally, a further electromechanical input device in the form of a rotary switch may be present.

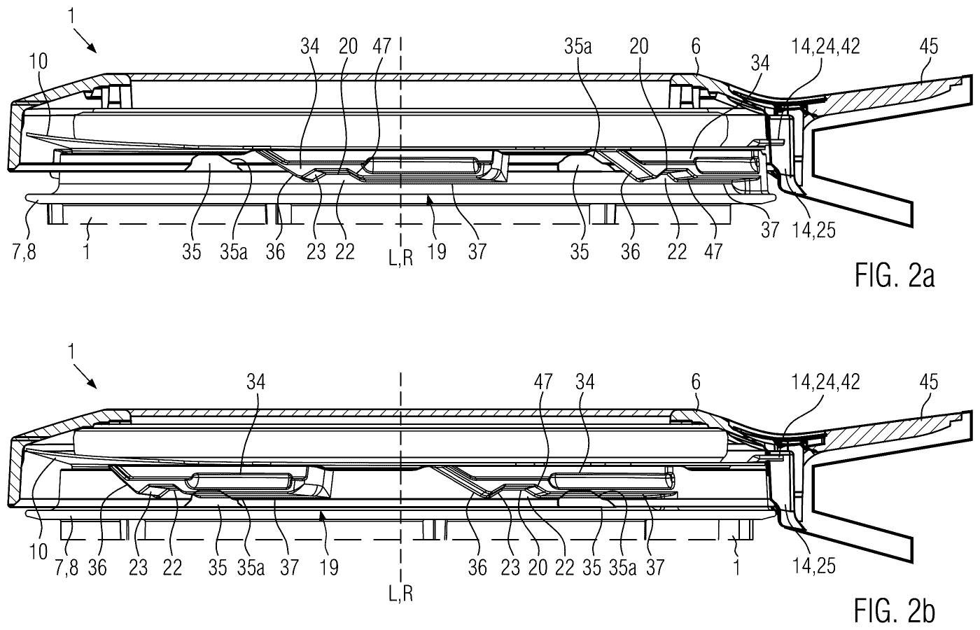

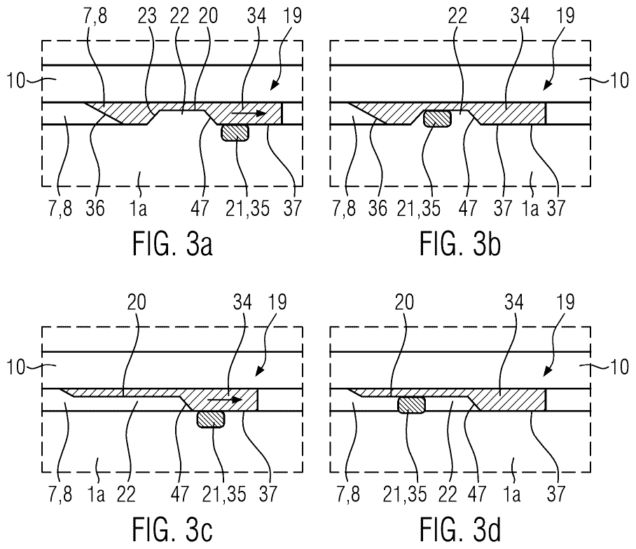

The structure of the preparation vessel 1a can be seen in particular in FIGS. 4 to 12c and FIG. 20. The preparation vessel 1a has at least one preparation chamber 5—see for example FIG. 4—for receiving food. The preparation chamber 5 can be closed with the lid 6, wherein the lid 6 can be locked with the preparation vessel 1a using a lid locking unit 7, as will be described below in particular with reference to FIGS. 2a to 2c. The lid 6 has a handle piece 45. The handle piece 45 has a first handle piece element 45a and a second handle piece element 45b that are arranged approximately V-shaped to each other.

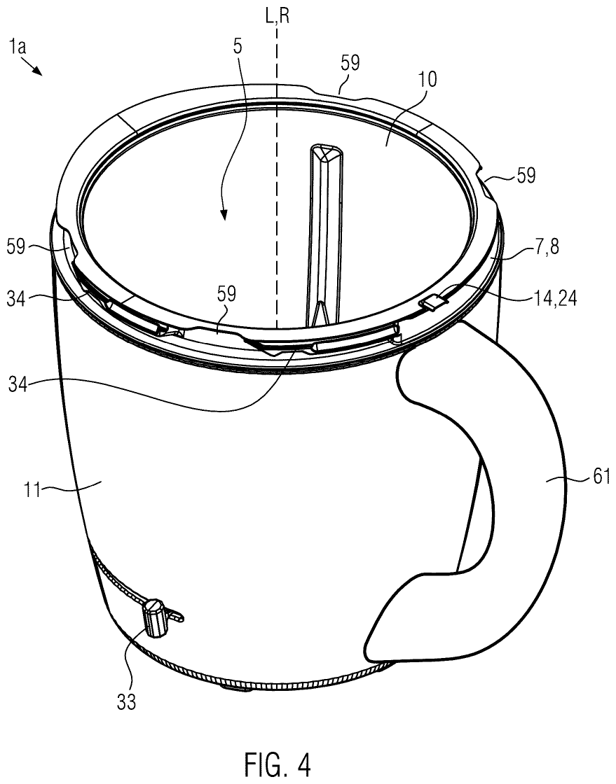

The preparation vessel 1a has an inner pot 10 according to FIGS. 4, 5 and 9, in which the preparation chamber 5 is formed. The inner pot 10 of the preparation vessel 1a can be inserted into a housing 11 and detachably lockable in the housing 11. The housing 11 is shown separately in FIGS. 5, 6, 7 and 20. FIG. 4 shows the completely assembled preparation vessel 1a with locked inner pot 10. FIG. 5 shows an exploded view, namely a view of the inner pot 10 during insertion respectively removal into or from the housing 11, for example for cleaning purposes. An electrical interface 9 of the preparation vessel 1a is firmly connected to the inner pot 10. Furthermore, a cable routing and electronics channel 60, which contains a subsequently described detection means 55, is arranged on the inner pot 10. A tool 26a, here a tool for cutting and stirring, is firmly connected to the removable tool holder 26. Alternatively, it is provided that the tool 26a is detachable from the tool holder 26. The tool holder 26 can then be inserted into the inner pot 10, preferably also locked, with and without tool 26a.

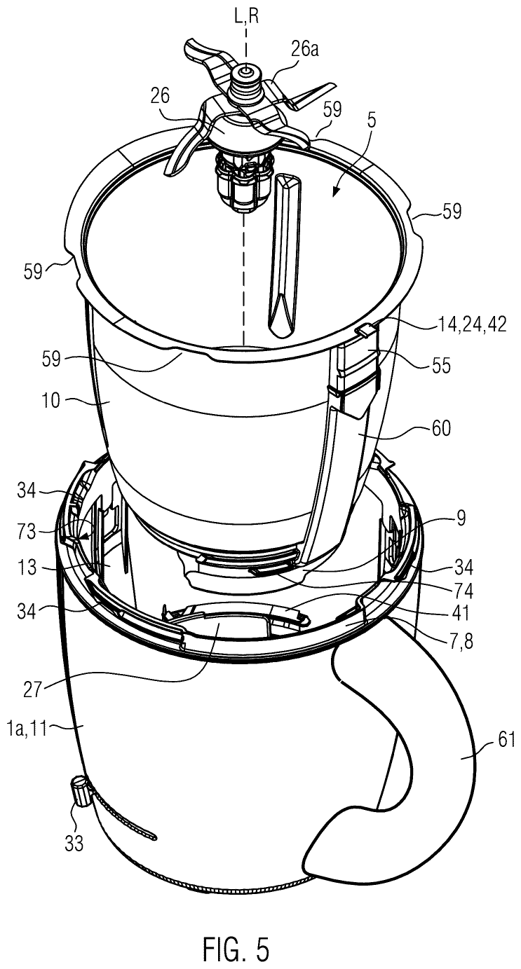

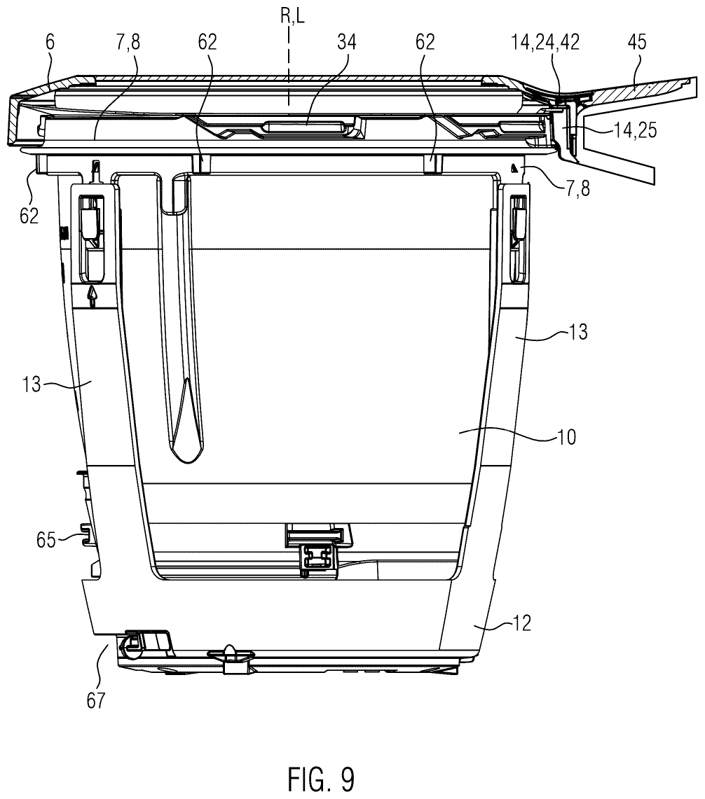

In the housing 11 of the preparation vessel 1a, a locking unit 27 as well as a counter-element 12, a transmission element 13 and a lid locking element 8 of a lid locking unit 7 are advantageously held rotatably about a rotation axis R respectively a longitudinal axis L of the preparation vessel 1a. In the assembled state-for example according to FIG. 4—in particular the transmission element 13 is arranged and rotatable in an intermediate space between the inner pot 10 and the housing 11. The counter-element 12, the transmission element 13 and the lid locking element 8 are designed such that they surround the inner pot 10 (see in particular FIG. 9, in which the housing 11 is omitted). FIG. 6 shows a perspective view into the housing 11 without inner pot 10. FIG. 6 shows the preparation vessel 1a in partially assembled representation. The inner pot 10 is removed. The locking unit 27 is rotatable on webs 41 on the inside of the housing 11 between stop positions.

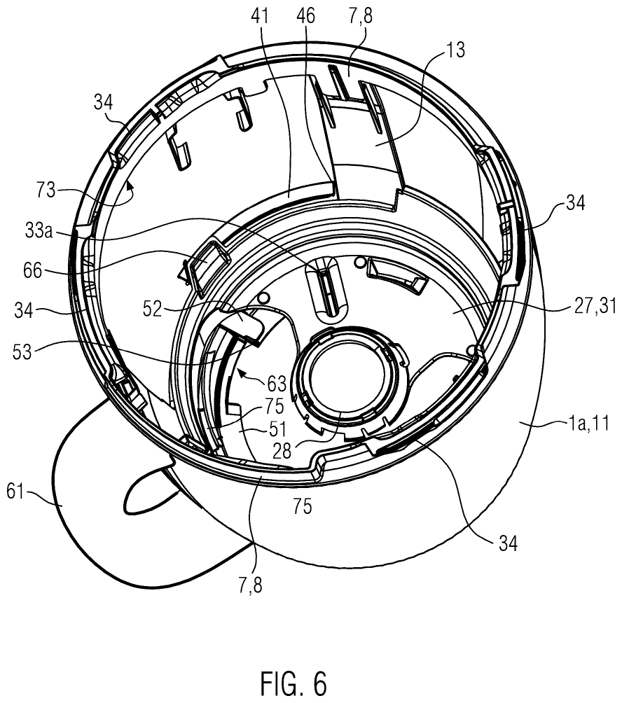

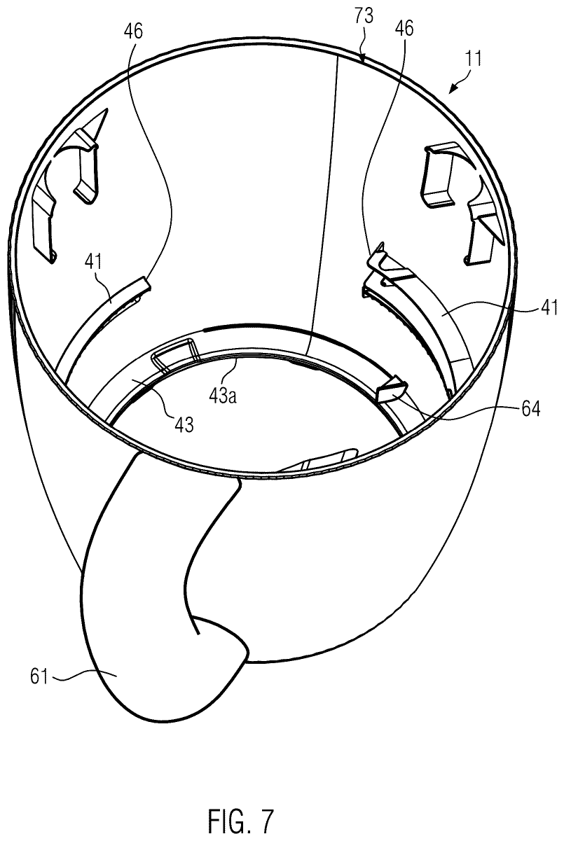

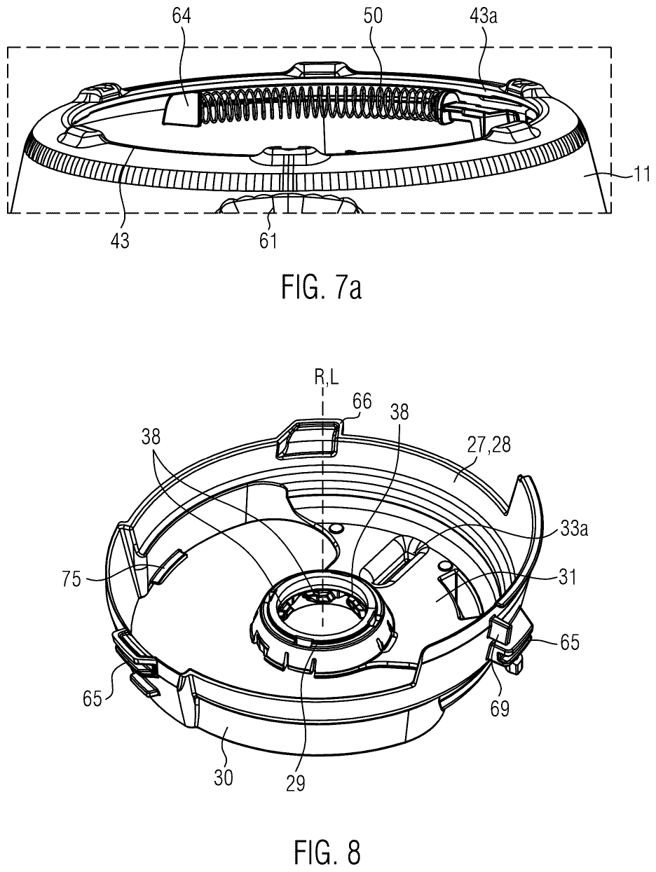

The cooperation between the webs 41 and, for example, a guide piece 66 of the locking unit 27 advantageously occurs according to the tongue-and-groove principle. The locking unit 27 also has grooves 65 in which the webs 41 can be guided (see also FIG. 8). In the state shown in FIG. 6, the carrier 28 of the locking unit 27 rests against the transmission element 13, so that the locking unit 27 respectively the carrier 28 according to FIG. 6 cannot be rotated counterclockwise. Furthermore, the transmission element 13 also cannot be rotated as long as the locking unit has not yet been moved. The transmission element 13 is supported in a counterclockwise rotation direction against an end stop 46 on one of the webs 41. Movement of the transmission element 13 from the position shown in FIG. 6—lid release position—in the clockwise rotation direction is limited by another end stop 46 on a web 41 (see FIG. 7). Consequently, two end stops 46 for the transmission element 13 are formed on the inside of the housing 11.

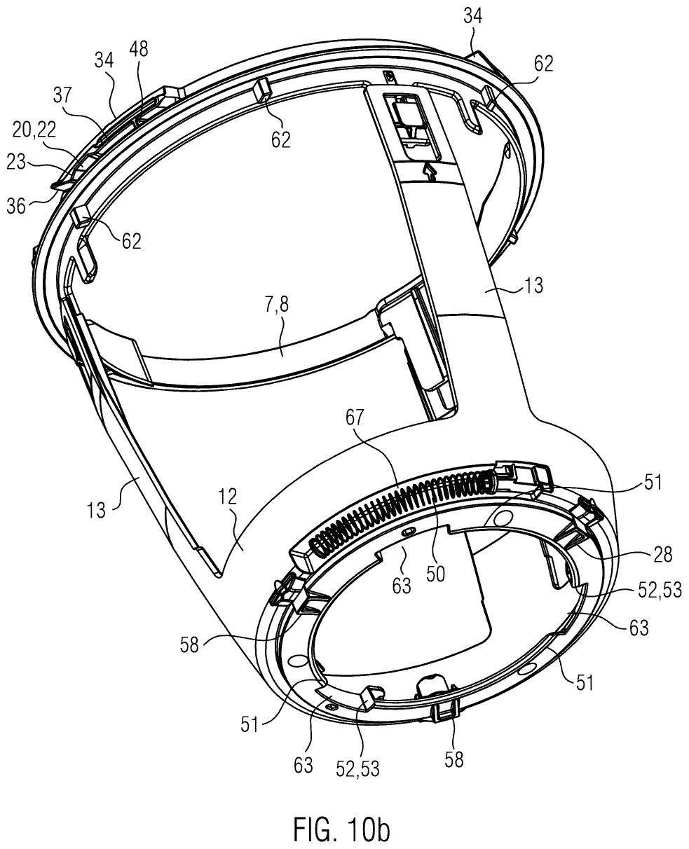

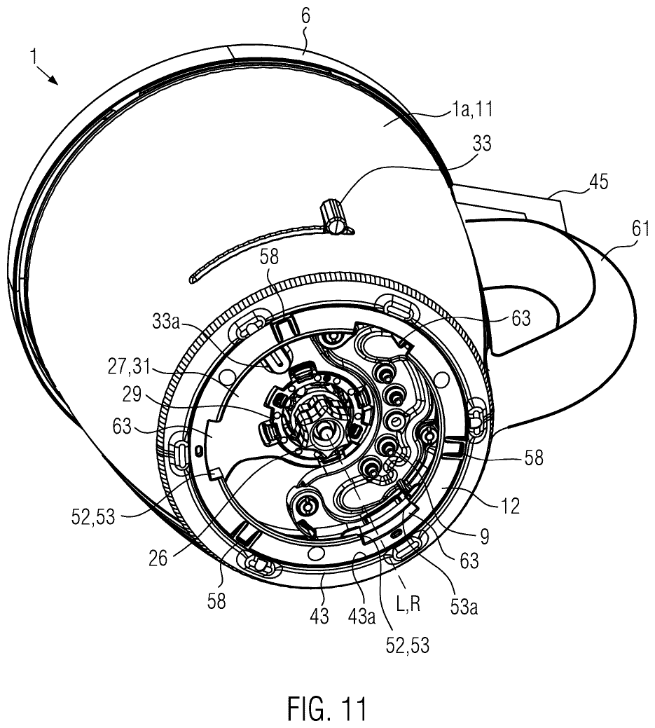

FIG. 7 shows a perspective view into the housing 11 without any attachments, consequently in particular only the shell. The housing 11 in this embodiment is formed from a thermally insulating material, here plastic. The distance between inner pot 10 and housing 11 provides additional thermal insulation. In the inserted state, the inner pot 10 is completely circumferentially and with respect to its height surrounded by the housing 11 (see FIG. 4). On its inside, the housing 11 according to FIGS. 5, 6, 7 and 20 has the described webs 41 that serve for mounting the locking unit 27. In particular, axial forces in a direction parallel to the rotation axis R can be transmitted from the locking unit 27 to the housing 11 via the webs 41. The housing 11 has an inward-projecting edge 43 in its lower area, on whose inner end face 43a the assembled counter-element 12 is supported with bearing points 58 in the radial direction (see in particular FIGS. 11 and 12a to 12c).

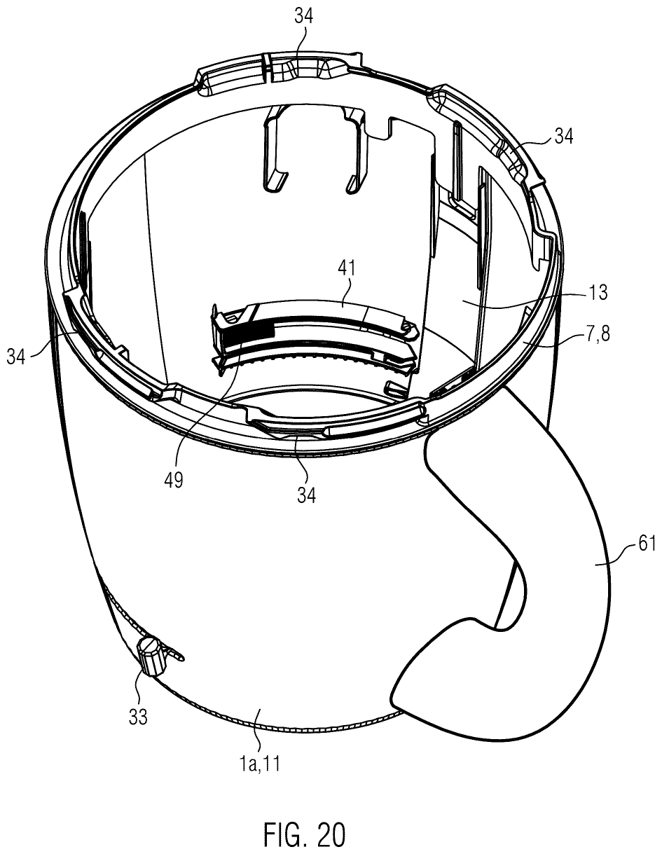

Below the web 41 shown on the right in FIG. 7, a channel is formed in which, according to FIG. 20, a first return means 49, here in the form of a spring, can be arranged. The first return means 49 cooperates in the assembled state with a projection 69 on the locking unit 27 (see for example FIG. 8) to always urge the locking unit 27 into a release position according to FIG. 12c so that a tool holder 26 can be inserted. Furthermore, a support element 64 for a second return means 50, here also in the form of a spring, is formed on a lower edge 43 (see in particular FIGS. 7 and 7a). In FIG. 7a, the second return means 50 is shown only for understanding purposes. The return means 50 is held in the assembled state in a receptacle 67 on the locking element 27 (see FIGS. 8, 9, 10a and 10b).

To assemble the inner pot 10 in the housing 11, first the inner pot 10 is introduced into the housing 11—see FIG. 5. Subsequently, a tool holder 26 with mounted tool 26a, here a cutting and stirring tool, is inserted through the inner pot 10 and through a locking ring 29 of a carrier 28 of the locking unit 27. The locking ring 29 has, for example, an inner diameter between 29.5 mm and 35.5 mm, in particular of about 32.5 mm. The locking ring 29 is connected to an outer ring 30 of the carrier 28 by a retaining web 31. Furthermore, the carrier 28 has a counter-rib 75 on an inside (see in particular FIG. 8) that—as will be described below—is designed for cooperation with a rib 74 on the inner pot 10 (see FIG. 5). FIG. 12c shows by way of example a view of the preparation vessel 1a from below with inserted inner pot 10, but still without tool holder 26. An electrical interface 9 of the inner pot 10 is accessible from the underside of the preparation vessel 1a so that it can cooperate with an electrical counter-interface 32 when the preparation vessel 1a is arranged in a receiving area 2 of a kitchen appliance base 3 (see FIGS. 1, 16 and 17).

The inner pot 10 has, in particular according to FIG. 5, in particular at a foot area, at least one rib 74. The rib 74 is oriented orthogonally to a rotation axis of the tool 26a for the inner pot 10. Preferably, the housing 11, in particular the locking unit 27, has at least one counter-rib 75 (see FIGS. 6 and 8). The counter-rib 75 is arranged in the locking position of the locking unit 27 such that it collides with the rib 74 on the inner pot 10 when an attempt is made to insert the inner pot 10 into the housing 11. This prevents the inner pot 10 from being insertable into the housing 11 when the housing 11—without inner pot 10—is arranged on a kitchen appliance base 3, in particular it is thus prevented that the inner pot 10 can be subsequently inserted. When the housing 11—alone—is arranged on the kitchen appliance base 3, cooperation with the actuating unit 2a prevents unlocking of the locking unit 27 from occurring. In the unlocking position of the locking unit 27, the inner pot 10 is insertable into the housing 11.

In FIG. 12c, the locking unit 27 is in a first position—release position—in which the tool holder 26 can pass through the locking ring 29. The locking unit 27 has an actuating handle 33 with which it can be rotated from the first position according to FIGS. 12c and 12b—release position—to a second position according to FIG. 12a—locking position. Alternatively or additionally to the first actuating handle 33, the locking unit 27 has an alternative actuating handle 33a that is accessible from the underside of the preparation vessel 1a.

According to FIG. 12b, the tool holder 26 is inserted but not yet locked with the locking unit 27. Locking occurs by a user moving the actuating handle 33—or the alternative actuating handle 33a—to the second position according to FIG. 12a. The locking ring 29, which can be passed through by the tool holder 26, has according to FIGS. 8 and 12a to 12c a plurality of hooks 38 on its inner circumference that are designed for form-fitting cooperation with the locking ring 29. When the locking unit 27 and thus also the hooks 38 on the locking ring 29 are rotated, form-fitting locking of the tool holder 26 with the locking unit 27 occurs through the hooks 38. Because the tool holder 26 also passes through the inner pot 10, the inner pot 10 is also locked with the housing 11 through the locking of the tool holder 26. For cleaning purposes, the tool holder 26 with the tool 26a and the inner pot 10 can be removed in reverse order, in particular by unlocking by moving the actuating handle 33 from the second position according to FIG. 12a to the first position according to FIG. 12b.

The locking unit 27 has a first return means 49 (see FIG. 20) in the form of a return spring. The first return means 49 acts between the housing 11 and the locking unit 27 to urge the locking unit 27 at least when no tool holder 26 is inserted in the direction of a release position for the tool holder 26 according to FIG. 12c. As a result, the actuating handle 33 is also always in the position according to FIG. 12c. In addition, a second return means 50, in particular also in the form of a return spring, is provided that acts between the locking unit 27 and the counter-element 12. The second return means 50 urges the counter-element 12 in the direction of a second position, which here corresponds to the locking position, so that the preparation vessel 1a cannot be arranged in the receiving area 2 of a kitchen appliance base 3 when no tool holder 26 is present or an existing tool holder 26 is not locked—as shown in FIG. 12a. In the state shown in FIG. 12b, placement in the receiving area 2 is not possible.

The lid locking element 8, the transmission element 13 and the counter-element 12 are rotationally fixed to each other according to FIGS. 6, 9, 10a and 10b so that they can be rotatably mounted about a rotation axis R within the housing 11 of the preparation vessel 1a (see in particular FIGS. 6 and 9). The lid locking element 8 is supported on an inner surface of the housing 11 respectively the shell at an upper edge 73 with a plurality of radial bearing points 62 (see FIGS. 6, 7 and 10b). The unit of lid locking element 8, transmission element 13 and counter-element 12 is mounted in the housing 11 in particular via the bearing points 62 of the lid locking element 8 and the bearing points 58 of the counter-element 12.

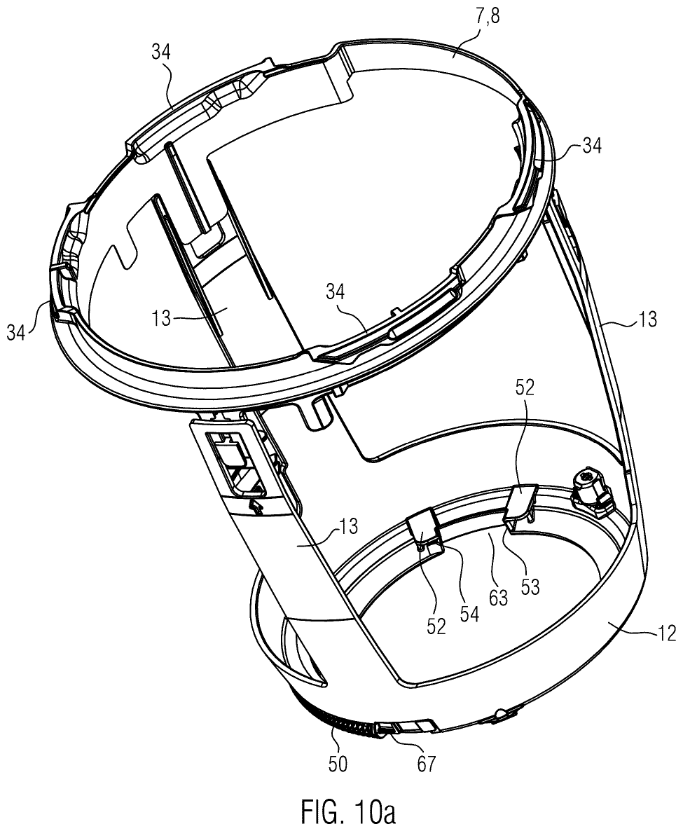

In this embodiment—as shown in particular in FIGS. 9 and 10a, 10b—the counter-element 12 and the transmission element 13 are formed in one piece, wherein the unit of counter-element 12 and transmission element 13 is form-fittingly connected to the lid locking element 8. The transmission element 13 has three substantially vertically extending arms, at the ends of which connection to the lid locking element 8 occurs in each case.

In the assembled state, in particular according to FIGS. 5, 6 and 9, the counter-element 12 is rotatable between a first position and a second position. Because the lid locking element 8 and the counter-element 12 are rotationally fixed to each other via the transmission element 13, the lid locking element 8 is in the lid release position when the counter-element 12 is in the first position, and the lid locking element 8 is in the lid locking position when the counter-element 12 is in the second position. Through this cooperation, rotation of the counter-element 12, in particular caused by the kitchen appliance base 3, can cause automatic locking and unlocking of the lid 6 as described below with reference to FIGS. 2a to 2c. The counter-element 12 is designed for cooperation with the kitchen appliance base 3, in particular with the actuating unit 2a in the receiving area 2.

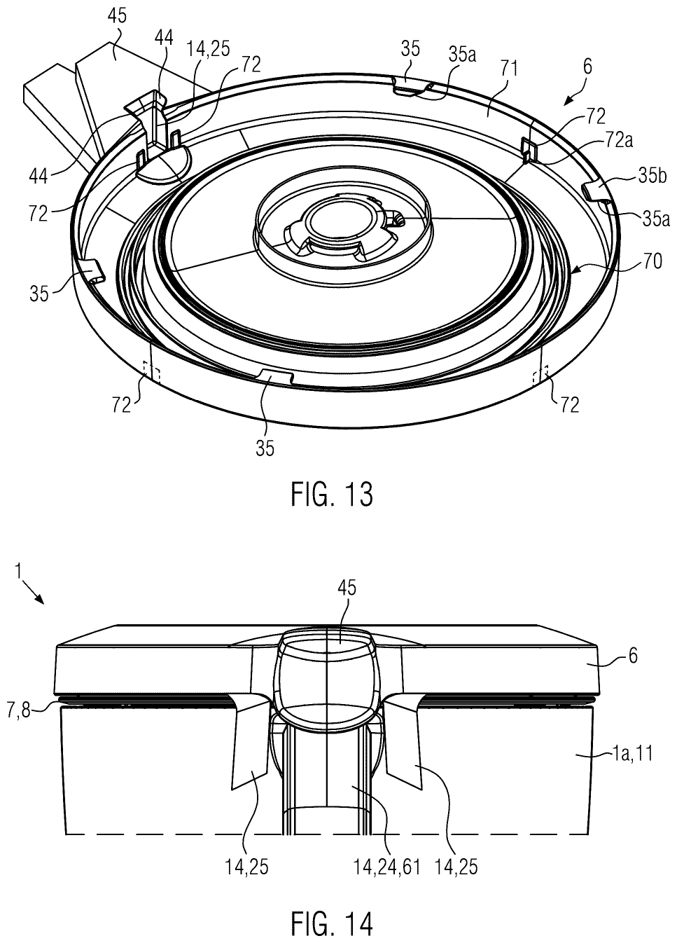

The preparation module 1, here the preparation vessel 1a with the lid 6, can be introduced into the receiving area 2 of a kitchen appliance base 3, as shown in FIG. 1. In particular, the preparation vessel 1a can be arranged with its foot area—with and without lid 6—in the receiving area 2. FIGS. 16, 17 and 21 show a detail view of a top surface 3a of a kitchen appliance base 3 with receiving area 2. The receiving area 2 has an actuating unit 2a with a drive unit 15, an actuating element 16 rotatably held about a rotation axis R1, and three stationary holding elements 17. The holding elements 17 are arranged at an angle of about 120° to each other and each have a convexly curved holding surface 17a that is oriented toward the top surface 3a.

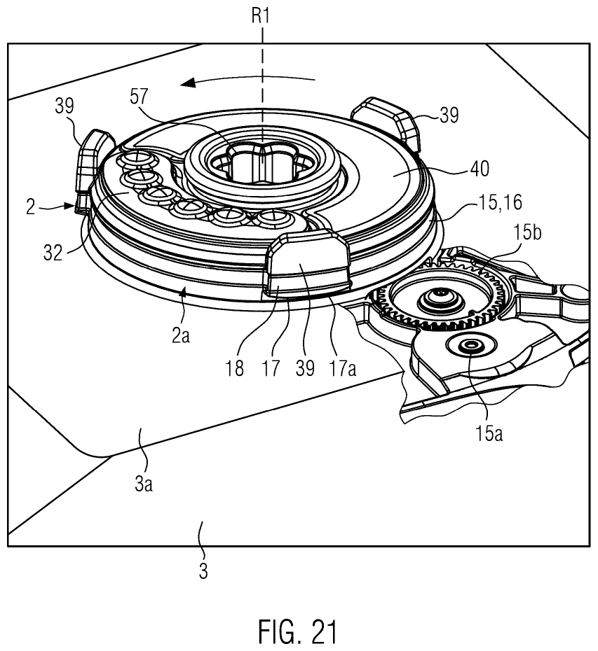

To be able to move the actuating element 16, the drive unit 15 has, in particular according to FIG. 21, at least one motor 15a and at least one gear wheel 15b. FIG. 21 shows an embodiment of a kitchen appliance base 3 with partial cutout. The gear wheel 15b is in form-fitting engagement with the actuating element 16 to rotate the actuating element 16. For example, the actuating element 16 has a toothing into which the gear wheel 15b engages—not shown. The motor 15a, of which only the shaft end is shown, is directly connected to the gear wheel 15b.

Above the holding elements 17, the actuating element 16 is rotatably arranged. The actuating element 16 has three driver elements 18 that in the first position shown in FIG. 16 completely overlap in a direction parallel to the rotation axis R1 of the actuating element 16. Above the driver elements 18, an insertion element 39 is arranged in each case, which like the holding element 17 is stationary. According to FIG. 16, the insertion element 39 in the first position is also in complete overlap with the driver element 18 respectively the holding element 17 in a direction parallel to the rotation axis R1. The electrical contacts of the counter-interface 32, which are designed for cooperation with the electrical interface 9 of the preparation vessel, e.g., according to FIG. 11, are covered with a contact cover 40. The actuating unit 2a surrounds a centrally arranged tool interface 57 that is designed for form-fitting cooperation with the tool holder 26 (see FIG. 11) and is joined with it when the preparation vessel 1a is arranged in the receiving area 2.

The holding elements 17 and/or the driver elements 18 and/or the insertion elements 39 have, for example, a width—in the circumferential direction—between about 23 mm and 27 mm. In particular, the width is about 25 mm. The driver elements 18 preferably have—in a direction parallel to the rotation axis R—a height between 3.5 mm and 5.5 mm. In particular, the height is about 4.5 mm. The actuating unit 2a has, starting from the top surface 3a of the kitchen appliance base 3, in particular about a height—up to the top of the contact cover 40—of about 16 mm to 20 mm. In particular, the height is about 18 mm. The insertion elements 39 preferably have, starting from the top surface 3a of the kitchen appliance base 3, about a height between 21 mm and 25 mm. In particular, the height is about 23 mm. The actuating unit 2a has—starting from the rotation axis R1—in particular a radius of 45 mm to 55 mm. In particular, the radius is about 50 mm. The same applies to the actuating element 16 and the contact cover 40. The insertion elements 39 and/or the driver elements and/or the holding elements 17 preferably have—starting from the rotation axis R1—a radius of about 49 mm to 61 mm. In particular, the radius is about 53.5 mm.

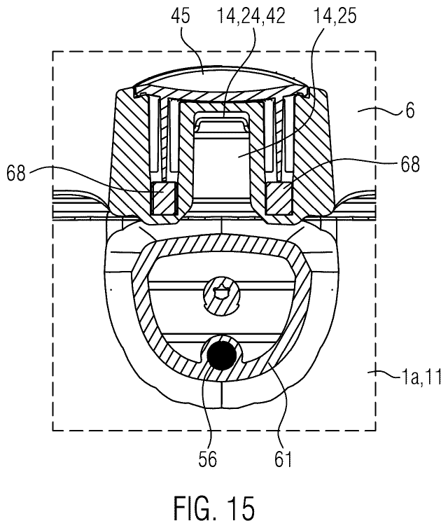

To effect a mechanical function on the preparation vessel 1a, the actuating element 16 with the driver elements 18 is rotatable by the drive unit 15 at least to a second position according to FIG. 17. In the second position, the driver elements 18 are swiveled out of the overlap in a direction parallel to the rotation axis R1 with the holding elements 17 and the insertion elements 39.

The actuating unit 2a protrudes from the top surface 3a of the kitchen appliance base 3 so that it can at least partially enter an underside of the preparation vessel 1a when the preparation vessel 1a is inserted into the receiving area 2.

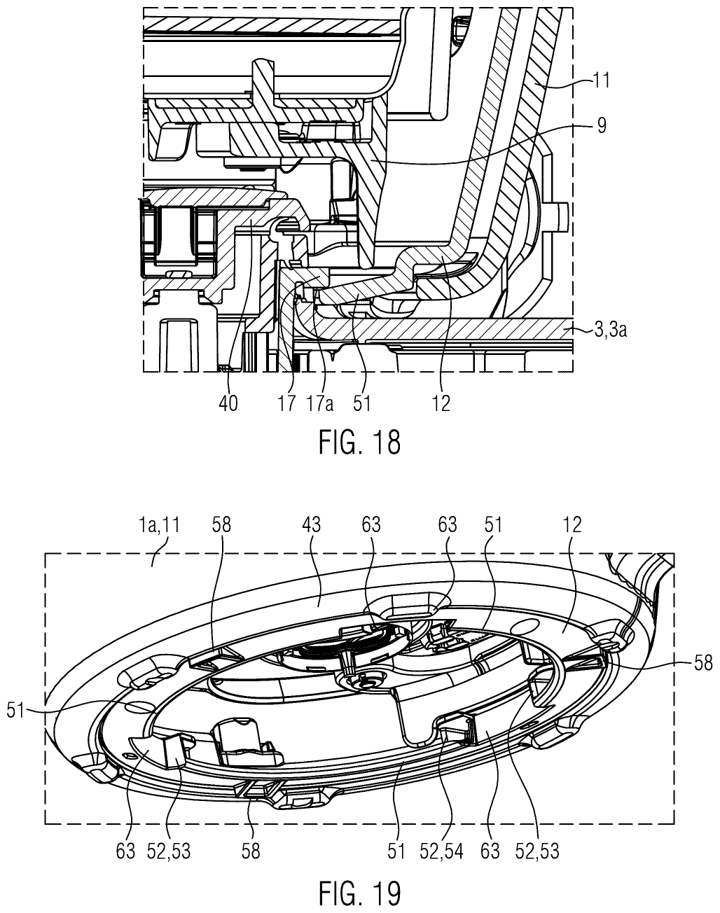

In the applied state of the preparation vessel 1a in the receiving area 2 of a kitchen appliance base 3, for example according to FIGS. 11, 16, 17, 18 and 19, an insertion element 39, a driver element 18 and a holding element 17 each pass through the counter-element 12 through one of the recesses 63. The recesses 63 are dimensioned such that entry can only occur when the insertion element 39, the driver element 18 and the holding element 17 completely overlap in a direction parallel to the rotation axis R1. The recesses have in particular a width—in the circumferential direction—of about 24 mm to 28 mm, in particular of about 26 mm. Furthermore, the actuating unit 2a enters the counter-element 12 from below through a central opening (see FIGS. 10b and 19). The central opening has a radius of about 47 mm to 57 mm, in particular of about 52 mm.

The electrical counter-interface 32 of the kitchen appliance base 3 is contacted with the electrical interface 9 of the preparation vessel 1a when introduced into the receiving area 2, for example according to FIG. 11. Furthermore, the tool interface 57 of the receiving area 2 is also connected to the corresponding interface of the tool holder 26 (see in particular FIG. 11).

The display and input device 3b is arranged on a device front of the kitchen appliance base 3, opposite is a device rear (see FIG. 1). When the preparation vessel 1a is arranged in the receiving area 2, the handle 61 of the preparation vessel 1a is oriented toward the display and input device 3b. The actuating unit 2a is further oriented such that an insertion element 39 of the actuating unit 2a is aligned approximately on an imaginary line with the handle 61. The insertion element 39 is oriented toward the device rear. The actuating unit 2a is essentially circular. Starting from the insertion element 39, which is aligned on a line with the handle respectively a central axis of the display and input device 3b, the two other insertion elements 39 are evenly distributed on the circumference. On the circumference opposite to the previously described insertion element 39, the electrical counter-interface 32 is arranged (see FIGS. 16 and 17). The electrical counter-interface 32 is oriented on the circumference toward the handle 61 respectively the device front. This arrangement supports positioning of the preparation module 1 when it is placed, for example, tilted slightly forward or backward. Either the rear insertion element 39 (the one arranged on the imaginary line, on the side facing the rear of the kitchen appliance base 3) or the two front insertion elements 39 (those arranged laterally from the electrical counter-interface 32) guide, which support the rough front alignment with regard to the contacts of the counter-interface 32.

The rotation of the driver elements 18 between a first position according to FIG. 16 and the second position according to FIG. 17 relative to the holding elements 17 and the insertion elements 39 is advantageously used to cause rotation of the counter-element 12, e.g., to effect a mechanical function within the preparation vessel 1a, in particular to lock the preparation vessel 1a with the kitchen appliance base 3. The rotation preferably occurs at an angle of about 30°, wherein preferably first an angle of about 32° is approached and then a return of about 2° occurs to reduce stresses in the moved components.

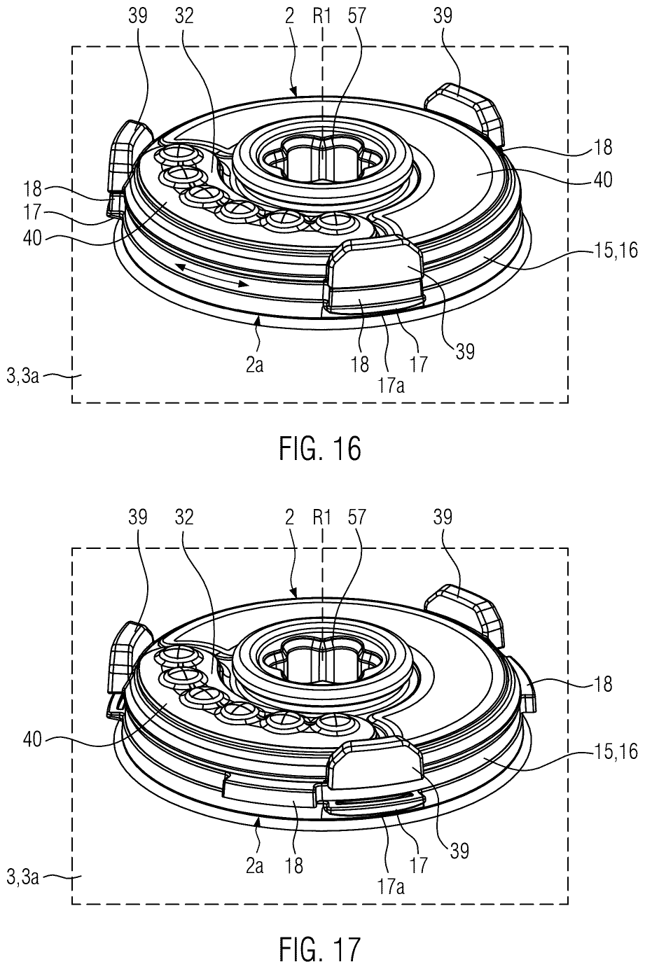

During rotation of the actuating element 16, the driver elements 18 are rotated, which each cooperate with a driver counter-surface 53 of the driver counter-element 52 of the counter-element 12 (see FIGS. 10a, 10b and 19) and thereby also cause rotation of the counter-element 12 in the intermediate space between inner pot 10 and housing 11. The counter-element 12 has a plurality of active sections 51 protruding in the direction of the rotation axis R1, which each have a driver counter-element 52 with a driver counter-surface 53. When the preparation vessel 1a is introduced into the receiving area 2, the rotation axes R, R1 and the longitudinal axis L are preferably coaxial. The driver counter-surface 53 is arranged offset along a direction parallel to the rotation axis R1 to the active section 51, namely located above the active section 51. Through rotation of the counter-element 12, the active sections 51 of the counter-element 12 are rotated under the concavely curved holding elements 17, whereby the preparation vessel 1a is locked with the kitchen appliance base 3. The locked state is shown in section in FIG. 18.

Since the counter-element 12 is rotationally fixed about the rotation axis R to the transmission element 13 and the lid locking element 8, when the counter-element 12 moves, the lid 6 is simultaneously locked or unlocked with the preparation vessel 1a by the locking cam tracks 34—as described below with reference to FIGS. 2a to 2c—cooperating with cams 35 on the lid underside of the lid 6.

In the illustrated embodiment, advantageous locking of the preparation vessel 1a with the kitchen appliance base 3 thus occurs simultaneously with locking of the lid 6 with the preparation vessel 1a. Unlocking of the preparation vessel 1a from the kitchen appliance base 3 occurs in reverse order, namely by the driver elements 18 cooperating in the opposite direction with the driver counter-element 52 of the counter-element 12, in particular with a return surface 54, and rotating the counter-element 12 so far in the opposite direction until the active sections 51 of the counter-element 12 no longer overlap with the holding elements 17 in a direction parallel to the rotation axis R, so that the holding elements 17, the driver elements 18 and the insertion elements 39 can exit outward through the recesses 63 again when the preparation vessel 1a is lifted from the receiving area 2 (see in particular FIG. 18).

At the same time, by rotating the counter-element 12 in the opposite direction via the transmission element 13, the lid locking element 8 is also rotated in the opposite direction, namely toward the lid release position, so that the lid 6 is removable in the lid release position.

However, if pressure is present in the preparation chamber 5 during rotation toward the lid release position or the user pulls on the lid 6, a blocking means 19 reaches the blocking position—as described below for FIGS. 2a to 2c—and thus prevents further rotation of the lid locking element 8, but also of the counter-element 12. This blocking is detected by the drive unit 15 respectively by the control unit based on an increased current strength and the rotation is stopped.

It is preferably provided that first a rotation in the opposite direction occurs, namely the active sections 51 are rotated back under the holding elements 17 and the locking cam tracks 34 are rotated back to the lid locking position. Only after a predetermined time has elapsed or by renewed initiation by a user is another process of unlocking or lid release started.

FIGS. 2a to 2c show an upper part of a preparation module 1, namely a lid 6 applied to a preparation vessel 1a in different locking states. The lid 6 has, for example, a total height—in a direction parallel to the longitudinal axis L—between about 24 mm and 28 mm. In particular, the total height is about 26 mm. At an upper edge of the preparation vessel 1a, the lid locking unit 7 is arranged, which can interact with the lid 6. FIG. 2a shows the lid locking unit 7 in the lid release position, FIG. 2b shows the lid locking unit 7 in the lid locking position, and FIG. 2c shows the lid locking unit 7 in a position between the lid locking position and the lid release position in which a blocking means 19 of the lid locking unit 7 is in a blocking position. Because the blocking means 19 is in the blocking position, movement of the lid locking unit 7 toward the lid release position according to FIG. 2a is prevented.

The blocking means 19 is in the blocking position according to FIG. 2c because a force parallel to a longitudinal axis L of the preparation vessel 1a away from the preparation vessel 1a acts on the lid 6. This force is caused either by a force from the preparation chamber 5 acting on the lid 6, for example emanating from a rotating vortex of food or pressure prevailing in the preparation chamber 5, or by a user attempting to lift the lid 6 from the preparation vessel 1a.

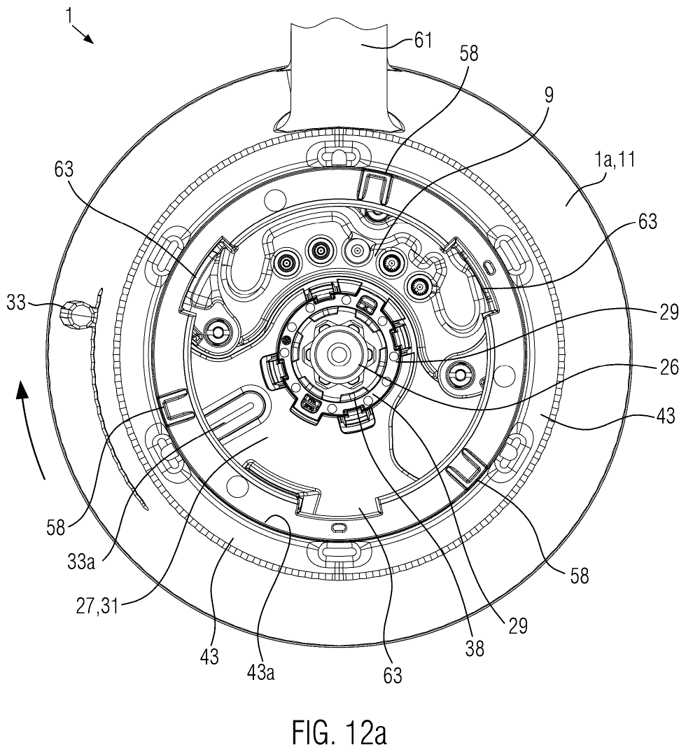

According to FIG. 2c, the lid locking unit 7 is at least partially moved toward the lid release position when the blocking means 19 is in the illustrated blocking position. The blocking means 19 reaches the blocking position through a translational movement of the lid 6, in particular in a direction parallel to the longitudinal axis L of the preparation vessel 1a (see FIG. 2c). The blocking means 19 has a plurality of first blocking surfaces 20, a plurality of second blocking surfaces 23, and a plurality of blocking elements 21. A translational movement of the lid 6 parallel to the longitudinal axis L is limited by the blocking elements 21 resting against the respective first blocking surface 20. The blocking elements 21 are here designed as radially inward-protruding cams 35 on the lid 6 (see also FIG. 13), which also serve for locking the lid 6.

The cams 35 have, for example, a width of about 10 mm to 14 mm, in particular of about 12 mm, and/or a depth—in the radial direction—between 5 mm and 7 mm, in particular of about 6 mm, and/or a height—in a direction parallel to the rotation axis R—between 3.5 mm and 5.5 mm, in particular of about 4.5 mm.

The first blocking surfaces 20 and the second blocking surfaces 23 are surfaces in a recess 22 in a locking cam track 34 that is formed on a lid locking element 8 of the lid locking unit 7. The first blocking surfaces 20 have, for example, a width between 5.5 mm and 7.5 mm, in particular of about 6.5 mm. The locking cam track 34 preferably has a height in a direction parallel to the rotation axis R of about 6.6 mm to 8.6 mm, in particular of about 7.6 mm. The lid locking element 8 is rotatably mounted about a rotation axis R, which coincides, for example, with the longitudinal axis L of the preparation vessel 1, at least between a lid release position and a lid locking position. The lid locking element 8 is essentially ring-shaped and is rotatable both relative to the lid 6 and relative to the preparation chamber 5 (see in particular FIGS. 2a and 2b). So that the cams 35 of the lid 6 according to FIGS. 2a to 2c can cooperate with the lid locking unit 7 respectively the lid locking element 8, the inner pot 10 according to FIGS. 4 and 5 has a number of recesses 59 in its upper edge 73 corresponding to the number of cams 35. The recesses 59 are preferably arranged in pairs, wherein an angle of about 60° is formed between the recesses 59 of a pair—starting from the longitudinal axis L. An angle of about 120° is formed between the recesses 59 of the two pairs in each case. In the embodiment of FIGS. 4 and 5 with an extension 42 on the inner pot 10, for example, an angle between the extension 42 and the first recess 59 adjacent to the extension 42 is about 60°. From each of the adjacent recesses 59 to the respective next recess 59, the angle is also about 60°.

The lid locking unit 7 has four locking cam tracks 34 on the lid locking element 8 that cooperate form-fittingly with the cams 35 to lock the lid 6 so that it closes the preparation chamber 5. The locking cam tracks 34 are rotatable together with the lid locking element 8 about the longitudinal axis L respectively the rotation axis R relative to the lid 6 as well as to the preparation chamber 5. For cooperation with the cams 35 formed on the lid 6, the locking cam tracks 34 each have a run-up slope 36 that causes an axial displacement of the cams 35 in a direction parallel to the longitudinal axis L of the preparation vessel 1a during rotation of the lid locking element 8 toward the lid locking position by the lid 6 being pulled toward the preparation chamber 5 at the cams 35. The run-up slope 36 has, for example, a length between 13 mm and 17 mm, in particular of about 15 mm. During further rotation of the lid locking element 8, the cams 35 each enter the recess 22 of the blocking means 19 and then slide out of the recess 22 along a guide slope 47 until they finally each rest against a locking surface 37 oriented substantially orthogonally to the longitudinal axis L to lock the lid 6. Preferably, the locking surface 37 and the first blocking surface 20 are arranged offset from each other by about 2.5 mm to 4.5 mm, in particular about 3.5 mm, along the rotation axis R.

If the lid locking unit 7 is in the lid locking position according to FIG. 2b and a user attempts to unlock the lid 6 by rotating the lid locking element 8 toward the lid release position, but a force emanating from the preparation chamber 5 still acts on the lid 6, the cams 35 are pressed into the recess 22 together with the lid 6 as part of a translational movement during movement toward the lid release position. Through the form-fitting cooperation of the cams 35 with at least part of the respective second blocking surface 23, further movement of the lid locking element 8 toward the lid release position is then mechanically blocked. The blocking means 19 is in the blocking position.

Through this function, the present disclosure ensures that the lid can only be opened by a user when no food can escape. In addition, it is ensured that blocking of the opening of the lid 6 only occurs when a force really acts on the lid 6. This avoids unnecessary waiting times for a user.

The rotatably mounted lid locking element 8 is supported at least in the lid locking position according to FIG. 2c on an underside of an upper edge of the inner pot 10 to achieve force transmission in a direction parallel to the longitudinal axis L of the preparation vessel 1a respectively the rotation axis R.

Exactly one stop element 48-see FIG. 10b—is formed on the lid locking element 8, which rests against exactly one cam 35, 35b in the lid locking position to prevent further rotation of the lid locking element 8 and thereby define the lid locking position. The resting can be detected, for example, by a control unit of the kitchen appliance base 3. The cam 35, 35b is arranged at approximately 240° in a polar coordinate system aligned with the lid 6—the lid underside—in which the longitudinal axis L respectively the rotation axis R forms the pole and the handle piece 45 is arranged at 0°. The cam 35, 35b whose resting is detectable is thus one of the cams 35 that is arranged furthest away from the support unit 14 compared to the other cams. This increases the reliability of detecting the resting. By using only one stop element 48, the lid locking position is uniquely defined. It is preferably provided that a drive unit 15 of the kitchen appliance base 3, with which the lid locking element 8 is preferably rotatable, detects an increased current strength at a motor and then switches off the motor. The stop element 48 is designed as part of the locking cam track 34 and extends perpendicular to the locking surface 37.

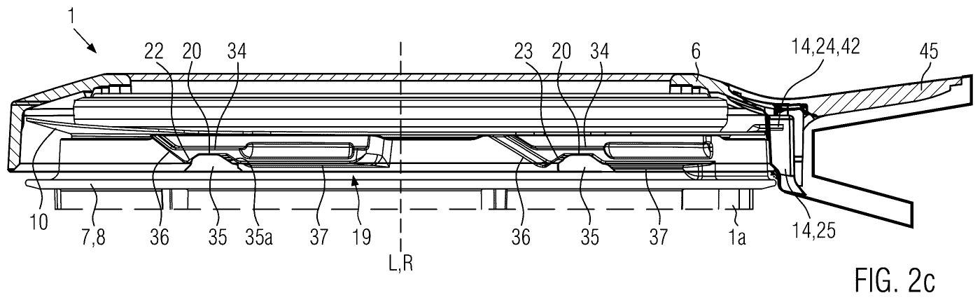

FIGS. 3a and 3b show an embodiment of a schematic structure of a blocking means 19 in partially sectioned detail view, which illustrates the functional principle of the blocking means 19 that is also used in FIGS. 2a to 2c. Starting from the lid blocking position in FIG. 3a, in which the cam 35 arranged on the lid 6 (see for example FIG. 13) rests against the blocking surface 37, rotation of the lid locking element 8 according to FIG. 3a occurs in the arrow direction to the right when the lid locking element 8 is to be moved to the lid release position. The cam 35 simultaneously forms a blocking element 21 of the blocking means 19.

If during movement of the lid locking element 8 toward the lid release position a force resulting from the preparation chamber 5 acts on the lid 6 or a user pulls on the lid 6, the blocking element 21 respectively the cam 35 moves through a translational movement of the lid 6 into the recess 22 of the blocking means 19 on the locking cam track 34 until the cam 35 rests against the first blocking surface 20 and the second blocking surface 23. The first blocking surface 20 limits the translational movement of the lid 6 away from the preparation vessel 1a and the second, obliquely arranged blocking surface 23 mechanically prevents further rotation of the lid locking element 8 toward the lid release position (see blocking position according to FIG. 3b). For example, this mechanical blockade is detected by a control unit of the kitchen appliance base 3, which causes rotation of the lid locking element 8 back to the lid locking position according to FIG. 3a.

FIGS. 3c and 3d show an alternative embodiment of a schematic structure of a blocking means 19 in partially sectioned detail view. According to FIG. 3c, the lid 6 is in the lid locking position in which the cam 35 of the lid rests against the locking surface 37. The cam 35 also forms the blocking element 21 of the blocking means 19 here. If the lid locking element 8 is now rotated to the right toward the lid release position according to FIG. 3c and a force emanating from the preparation chamber 5 acts on the lid 6 or a user pulls on the lid 6, a translational movement of the lid 6 and thus of the cam 35 into the recess 22 occurs until the cam 35 rests against the first blocking surface 20. The translational movement of the lid 6 is detected, for example, by a sensor—not shown—and further movement of the lid locking element 8 toward the release position is stopped. In this embodiment, the recess 22 has no second blocking surface 23; the blocking occurs by means of the control unit.

The lid locking element 8 is—as described—rotatable according to FIGS. 2a to 2c between a lid release position and a lid locking position to lock the lid 6 with the preparation vessel 1a. To prevent the lid 6 from rotating about the rotation axis R of the lid locking element 8 during movement of the lid locking element 8, the preparation module 1 according to FIGS. 2a to 2c, 4, 5, 13, 14 and 15 has a support unit 14 that is designed such that it allows axial movement of the lid 6 in a direction parallel to the rotation axis R respectively to the longitudinal axis L, but at the same time prevents rotation of the lid 6 when it is applied to the preparation vessel 1a. The support unit 14 has according to the embodiments of FIGS. 2a to 2c, 4, 5, 13 and 15 a support element 24 in the form of an extension 42 on the inner pot 10 and a support counter-element 25 in the form of a recess on the lid 6.

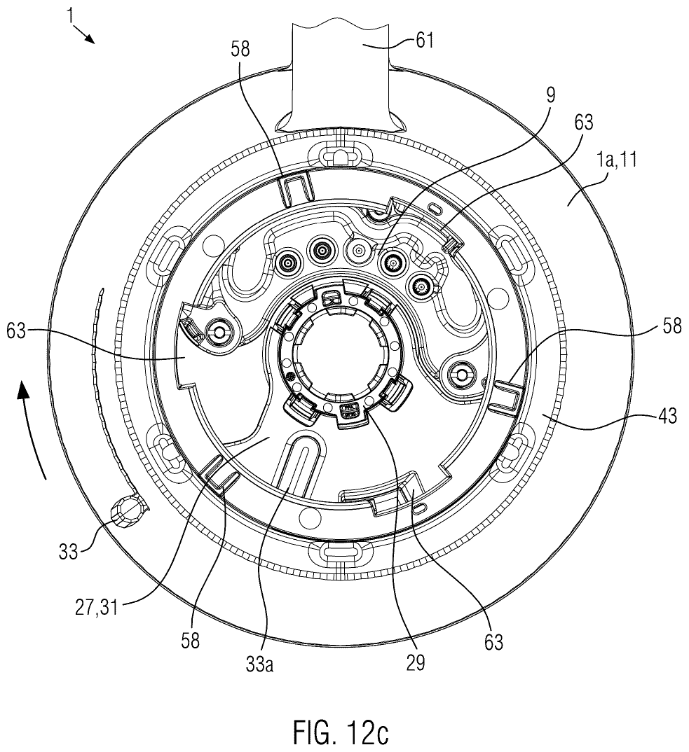

The support counter-element 25 and the support element 24 cooperate form-fittingly in the applied state of the lid 6 so that the lid 6 cannot rotate about the rotation axis R, but can be removed from the preparation vessel 1a in a direction substantially parallel to the rotation axis R (see in particular FIG. 15). The support element 24 in the form of the extension 42 can move in the height direction of the support counter-element 25 in the form of the recess, in particular during locking of the lid 6 with the preparation vessel 1a. The different positions of the support element 24 in the support counter-element 25 can be seen, for example, in FIGS. 2a to 2c. In the lid locking position according to FIG. 2b, the position is different than in the lid release position according to FIG. 2a.

Additionally, the support element 24 and the support counter-element 25 are designed such that the lid 6 can be tilted upward about an axis defined by the support element 24 by pressing on the handle piece 45. The support element 24 in this embodiment is designed as a substantially U-shaped extension 42 on the inner pot 10. The extension 42 is formed in one piece with the inner pot 10. In particular according to FIGS. 4 and 5, the extension 42 is formed on an upper edge 73 of the inner pot 10. To facilitate in particular the insertion of the support element 24 into the support counter-element 25, the support counter-element 25 according to FIG. 13 has two insertion slopes 44 formed opposite to each other, which facilitate the sliding in of the extension 42 according to FIGS. 4 and 5 when applying the lid 6 to the preparation vessel 1a (see also FIG. 15). According to FIGS. 13 and 15, the support counter-element 25 is arranged in the area of the handle piece 45 of the lid 6.

FIG. 13 shows a lid 6 for a preparation vessel 1 from an underside. In the area of the handle piece 45, the lid 6 has the support counter-element 25 in the form of an elongated recess that extends substantially parallel to the rotation axis R respectively to the longitudinal axis L of the preparation vessel 1a when the lid 6 is on the preparation vessel 1a. The support counter-element 25 serves to prevent rotation of the lid 6 during movement of the lid locking element 8 by the support counter-element 25 cooperating form-fittingly with the support element 24 in the form of the extension 42 on the inner pot 10 (see FIGS. 2a to 3c, 4, 5 and 9) when the lid 6 is applied to a preparation vessel 1a. The four cams 35 extend radially inward. Each cam 35 has an inclined cam surface 35a for cooperation with the run-up slope 36 of a locking cam track 34 (see FIGS. 2a to 2c).

In a polar coordinate system aligned with the lid 6—the lid underside—in which the longitudinal axis L respectively the rotation axis R forms the pole and the handle piece 45 is arranged at 0°, the cams 35 are arranged at about 60°, 120°, 240° and 300°. The angle between the handle piece 45 and the respective first cam 35 on the circumference in both directions is thus about 60°. The angle between two cams 35 adjacent on one side of the handle piece 45 is also about 60°.

To ensure centering of the lid 6 on the preparation vessel 1a, the lid 6 has a plurality of centering elements 72 on the lid underside. According to FIG. 13, exactly five centering elements 72 are formed on the lid 6. The centering elements 72 protrude in the area of the setback 70 from an inner edge 71 of the setback 70 in the direction of the longitudinal axis L. The centering elements 72 are arranged in particular facing away from a free edge of the inner edge 71. Each centering element 72 extends only over part of the height of the inner edge 71 in the setback 70.

A first centering element 72 is arranged on the circumference of the lid 6 opposite to the handle piece 45. A second and a third centering element 72 are arranged in a polar coordinate system on the lid underside, in which the longitudinal axis L forms the pole and the handle piece is arranged at 0°, at angles of about 90° and about 270° on the circumference. The second and third centering elements 72 are advantageously arranged opposite to each other. Furthermore, a fourth and a fifth centering element 72 are each arranged on one side of the support counter-element 25 of the support unit 14.

At least the second and third centering elements 72 each have a web 72a that protrudes from the centering element 72 in the radial direction. The web 72a advantageously serves for axial positioning of the lid 6 in the state applied to a preparation vessel 1a.

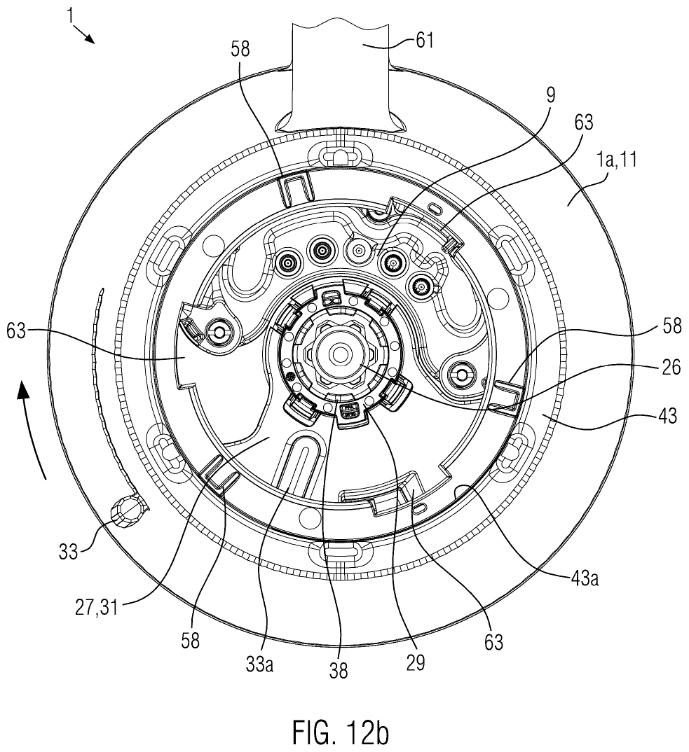

FIG. 14 shows an alternative embodiment of a support unit 14 that is formed on an outside of the lid 6 and the preparation vessel 1a. The support element 24 is formed by a handle 61 of the lid 6, wherein the support counter-element 25 is formed as webs on the lid 6 formed to the right and left of the handle 61. Furthermore, it is also conceivable that the support counter-element 25 is arranged in the form of two webs on the housing 11, and that the handle piece 45 serves as support element 24.

FIG. 15 shows a section through the handle 61 of the preparation vessel 1a and at least partially through the lid 6 in the area of the handle piece 45. In the illustrated section, the support counter-element 25 is shown in the form of a recess extending substantially parallel to the longitudinal axis L of the preparation vessel 1a, into which the support element 24 in the form of an extension 42 protruding from the inner pot 10 is introduced. The extension 42 is substantially U-shaped and connected in one piece to the inner pot 10. The extension 42 can move in the vertical direction according to FIG. 15 in the support counter-element 25. For insertion during application of the lid 6, the support counter-element 25 has the two insertion slopes 44 arranged opposite to each other. Furthermore, the lid can be tilted about an axis defined by the support element 24, for example by pressing on the handle piece 45, so that it opens at least on one lid side.

In the area of the attachment of the handle 61, a first identification means 56 is arranged, which is designed as a permanent magnet. A detection means 55 on the inner pot 10, which is arranged in particular in a cable routing and electronics channel 60, is designed to detect the presence and/or orientation of the magnet—its polarization. This allows the control unit of a kitchen appliance base 3 to detect whether the inner pot 10 is arranged in a housing 11 or not.

In the lid 6, in particular in the handle piece 45, a second identification means 68 in the form of two permanent magnets is also arranged. The detection means 55 is designed to detect the presence and/or orientation of the permanent magnets. Through different orientation—polarization—of the permanent magnets, for example, up to four different lids 6 can be detected.

Through different orientation of the two permanent magnets North-South, South-North, North-North and South-South, a total of four codings can be queried with which, for example, different embodiments of the lid 6 can be detected with the detection means 55. Depending on the embodiment of the lid 6, the second identification means 68 in the form of the permanent magnets is preferably coded differently. In addition, the presence of the second identification means 68 makes it detectable that a lid 6 is applied to the preparation vessel 1a at all.

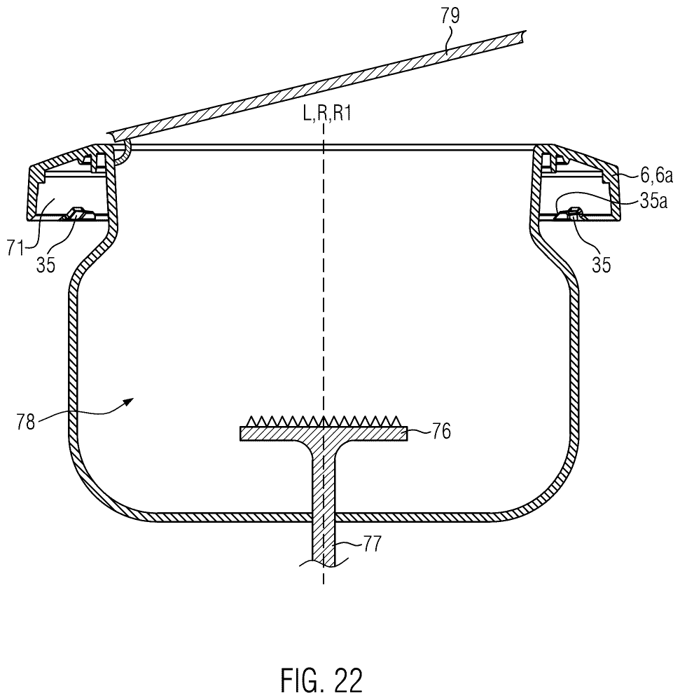

FIG. 22 shows an embodiment of a functional module 6a in sectional view. Since the functional module 6a has a lid interface, here e.g., with cams 35 on an inner edge 71, for cooperation with the lid locking unit 7 respectively the lid locking element 8, it is a lid 6 that is designed as a functional module 6a. The functional module 6a has an accessory tool 76 that can be mechanically coupled via a connection interface 77 to a tool 26a and/or a tool holder 26 of a preparation vessel 1a (see e.g., FIG. 5), in particular to transmit torque to the accessory tool 76. This makes the accessory tool 76 rotatable about the rotation axis R1, which here coincides with the longitudinal axis L and the rotation axis R. An interior space 78 of the functional module 6a can be closed with a cover element 79 that is removable from the functional module 6a and/or pivotably mounted. In the assembled state, the functional module 6a partially protrudes into the preparation chamber 5 of a preparation vessel 1a respectively of an inner pot 10.

The invention is not limited to the illustrated and described embodiments, but also includes all embodiments having the same effect within the meaning of the invention. It is expressly emphasized that the embodiments are not limited to all features in combination, rather each individual partial feature can also have inventive significance detached from all other partial features. Furthermore, the invention is also not yet limited to the feature combination defined in the preparation module, but can also be defined by any other combination of specific features of all individually disclosed features. This means that in principle practically every individual feature of the preparation module can be omitted or replaced by at least one individual feature disclosed elsewhere in the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A preparation module for arrangement in a receiving area of a kitchen appliance base, wherein the preparation module has at least one preparation vessel and at least one lid, wherein the preparation vessel has at least one preparation chamber for receiving food and at least one lid locking unit, wherein the lid is removable in at least one lid release position of the lid locking unit and is locked with the preparation vessel in at least one lid locking position of the lid locking unit, wherein the lid locking unit has at least one blocking means, wherein the blocking means in a blocking position prevents movement of the lid locking unit at least into the lid release position, at least when a force from the preparation chamber acts on the lid,
wherein the lid locking unit is at least partially moved toward the lid release position when the blocking means is in the blocking position, and that the blocking means reaches the blocking position at least through a translational movement of the lid.

2. The preparation module according to claim 1, wherein the blocking means has at least one first blocking surface and at least one blocking element, and that the translational movement of the lid is limited by the blocking element resting against the first blocking surface.

3. The preparation module according to claim 2, wherein the blocking means has at least one second blocking surface, and that the blocking element in the blocking position is mechanically prevented from movement in at least one direction by at least partially resting against the second blocking surface, in particular that the second blocking surface is a side surface in a recess.

4. The preparation module according to claim 2, wherein the lid locking unit has at least one lid locking element rotatably mounted about a rotation axis R, and that at least the first blocking surface is formed on the lid locking element.

5. The preparation module according to claim 1, wherein the lid locking unit has at least one locking cam track and at least one cam for locking the lid, that the cam and the locking cam track cooperate form-fittingly to lock the lid.

6. The preparation module according to claim 5, wherein the locking cam track has at least one run-up slope, and that the run-up slope causes at least an axial displacement of the cam in a direction parallel to a longitudinal axis L of the preparation vessel during movement of the lid locking unit.

7. The preparation module according to claim 6, wherein the locking cam track has at least one locking surface, and that the cam rests against the locking surface in the locking position, and that at least the first blocking surface is arranged between the run-up slope and the locking surface of the locking cam track.

8. The preparation module according to claim 5, wherein the cam is also the blocking element of the blocking means, and that the cam is forced into the blocking position during movement toward the lid release position when a force acts on the lid in a direction parallel to a longitudinal axis L of the preparation vessel.

9. The preparation module according to claim 1, wherein the first blocking surface is arranged in a recess, and that the recess has at least one guide slope.

10. Preparation The preparation module according to claim 1, wherein the preparation vessel has at least one inner pot and at least one housing, wherein a lid locking element of the lid locking unit is supported at least in the lid locking position at least on an underside of an edge of the inner pot.

11. The preparation module according to claim 1, wherein the lid locking unit has at least one stop element, and that the stop element limits movement of the lid locking unit in the lid locking position.

12. The preparation module according to claim 1, wherein the lid locking unit has at least one lid locking element rotatably mounted about a rotation axis R, that at least one counter-element and at least one transmission element are present, wherein the counter-element is designed for cooperation with a kitchen appliance base, and wherein the counter-element and the lid locking element are connected to each other via the transmission element such that rotation of the locking element about the rotation axis R causes rotation of the lid locking element.

13. A kitchen appliance having at least one kitchen appliance base and at least one preparation module according to claim 1, wherein the kitchen appliance base has at least one receiving area for the preparation vessel, wherein the receiving area has at least one actuating unit for mechanically locking the preparation vessel, wherein the actuating unit has at least one drive unit, at least one actuating element rotatably held about a rotation axis R, and at least one stationary holding element, wherein the kitchen appliance base has at least one control unit, and that the control unit is configured and designed to detect whether the blocking means is in the blocking position and to stop the drive unit when the blocking means is in the blocking position.

14. The kitchen appliance according to claim 13, wherein the control unit is configured and designed to cause the drive unit to transfer the lid locking unit to the lid release position when the control unit detects that the blocking means is no longer in the blocking position.

15. The kitchen appliance according to claim 13, wherein the control unit is configured and designed to cause the drive unit, after detecting the blocking position, to transfer the lid locking unit back to the lid locking position and to move the lid locking unit again toward the lid release position.

16. A method for operating a preparation module with a preparation vessel and a lid or a functional module, having at least the following method steps:
Rotating a lid locking unit on the preparation vessel about a rotation axis R at least between a lid release position and a lid locking position to lock and unlock the lid or the functional module,
Moving a blocking means to a blocking position when at least one force from the preparation chamber acts on the lid or the functional module during rotation of the lid locking unit toward the lid release position, wherein moving the blocking means to the blocking position comprises a translational movement of the lid or the functional module relative to the preparation vessel.

17. A method of using a preparation module, the method comprising the steps of: providing a preparation module according to claim 1 on a kitchen appliance base of a kitchen appliance; and operating the preparation module to prepare food by chopping, grinding, pressing, stirring, cooking, steaming, and/or keeping warm.

18. The preparation module according to claim 4, wherein the lid locking element is rotatable relative to the lid and relative to the preparation chamber.

19. The preparation module according to claim 6, wherein a first blocking surface is arranged axially offset to the locking surface.

20. The preparation module according to claim 8, wherein the cam is arranged on the lid and the locking cam track is arranged on a lid locking element rotatable about a rotation axis.

21. The preparation module according to claim 1, wherein the lid is designed as a functional module.

22. The preparation module according to claim 11, wherein the stop element is formed on the lid locking element or wherein the stop element is formed on the locking cam track.

23. The kitchen appliance according to claim 13, wherein the control unit is configured and designed to cause the drive unit to transfer the lid locking unit to the lid release position when a predetermined waiting time has elapsed after the control unit has detected that the blocking means is in the blocking position.
